(19) United States
(12) Patent Application Publication
(10) Pub. No.: US 2025/0270455 A1
(43) Pub. Date: Aug. 28, 2025

(54) HYDROCARBON PURIFICATION

(71) Applicant: LUTROS, LLC, Chattanooga, TN (US)

(72) Inventors: Travis DANNER, Chattanooga, TN (US); Mark MAUSS, Dubuque, IA (US)

(21) Appl. No.: 19/060,519

(22) Filed: Feb. 21, 2025

Related U.S. Application Data
(60) Provisional application No. 63/660,970, filed on Jun. 17, 2024.
(60) Provisional application No. 63/557,009, filed on Feb. 23, 2024.

(51) Int. Cl. C10G 49/24; C10G 49/22; C10G 49/26

(52) U.S. Cl. CPC C10G 49/24; C10G 49/22; C10G 49/26; C10G 2300/202; C10G 2300/4012; C10G 2300/44; C10G 2300/807

(57) ABSTRACT

Embodiments of the present disclosure generally relate to methods and systems for purifying hydrocarbons, such as feedstock hydrocarbons containing one or more contaminants. In one or more embodiments, a method of purifying a hydrocarbon is provided and includes flowing a feedstock hydrocarbon stream through a heating unit, then combining the hydrocarbon stream and a primary solvent in a laminar flow reactor to produce a hydrocarbon-solvent stream, flowing the hydrocarbon-solvent stream through a cooling unit, and introducing the hydrocarbon-solvent stream into a separation unit to produce a scrubbed hydrocarbon stream and a solvent stream. The scrubbed hydrocarbon stream has a final contaminant concentration which is less than the initial contaminant concentration. The methods and systems for purifying hydrocarbons may be used to prepare a purified hydrocarbon product having the contaminant reduced by 10 times, about 40 times, about 100 times, or greater compared to the feedstock hydrocarbons.

### CROSS-REFERENCE TO RELATED APPLICATIONS

This application claims benefit to U.S. Prov. Appl. No. 63/557,009, filed on Feb. 23, 2024, and claims benefit to U.S. Prov. Appl. No. 63/660,970, filed on Jun. 17, 2024, which are both herein incorporated by reference in their entirety.

### BACKGROUND

### Field

Embodiments of the present disclosure generally relate to methods and systems for processing hydrocarbons, and more specifically, methods and systems for purifying hydrocarbons including oils, fats, and/or greases.

### Description of the Related Art

Purification of hydrocarbons, e.g., fats, oils, and/or greases occurs for a variety of industries, e.g., food, cosmetics, waxes, biofuels, and other oleochemical products. Typically, hydrocarbons are purified using one or more steps to solubilize contaminants in an aqueous stream through the use of water washing and separation techniques, such as centrifuging. Remaining contaminants are then further adsorbed and/or filtered out by using adsorbent filtrations, such as “bleaching clays”—such as silica, diatomaceous earth, and/or carbon black. Unfortunately, each of these processes is costly, where each subsequent process increases the capital and operating expenses along with waste disposal and important product loss. Attempts to reduce waste disposal and product loss have implemented high shear mixing, cavitation, filtration powers, chelating agents, and enzymes. While these efforts have increased efficiency and yield, the capital and operating expenses remained the same.

Therefore, there is a need for improved methods and systems for purifying hydrocarbons, especially methods for purifying oils, fats, and/or greases from vegetable and/or animal sources.

### BRIEF DESCRIPTION OF THE DRAWINGS

So that the manner in which the recited features of the present disclosure may be understood in detail, a more particular description of the disclosure, briefly summarized, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 is a flowchart depicting a method for purifying a feedstock hydrocarbon, according to one or more embodiments described and discussed herein.

FIG. 2 depicts a system for purifying a feedstock hydrocarbon, according to one or more embodiments described and discussed herein.

FIG. 3 depicts another system for purifying a feedstock hydrocarbon, according to one or more embodiments described and discussed herein.

FIG. 4 depicts a system containing a liquid-filled laminar flow reactor, the system is configured to purify a feedstock hydrocarbon, according to one or more embodiments described and discussed herein.

FIG. 5 depicts a system containing a vapor-infused laminar flow reactor, the system is configured to purify a feedstock hydrocarbon, according to one or more embodiments described and discussed herein.

FIG. 6 depicts a system for purifying a feedstock hydrocarbon and recycling process water, according to one or more embodiments described and discussed herein.

FIG. 7 depicts a system for purifying and recycling process water, according to one or more embodiments described and discussed herein.

To facilitate understanding, identical reference numerals have been used, where possible, to designate identical elements that are common to the Figures. It is contemplated that elements and features of one or more embodiments may be beneficially incorporated in other embodiments.

### SUMMARY

Embodiments of the present disclosure generally relate to methods and systems for purifying hydrocarbons, such as feedstock hydrocarbons containing one or more contaminants. In some examples, the feedstock hydrocarbons may be or include oils, fats, and/or greases derived from one or more vegetable and/or animal sources. The contaminant may be or include one or more inorganics. The methods and systems for purifying hydrocarbons may be used to prepare a purified hydrocarbon product having the contaminant reduced by 10 times, about 40 times, about 100 times, or greater compared to the feedstock hydrocarbons. In some examples, the contaminant is not detectable in the purified hydrocarbon product.

In one or more embodiments, a method of purifying a hydrocarbon is provided and includes flowing a feedstock hydrocarbon stream through a heating unit to produce a heated hydrocarbon stream, where the feedstock hydrocarbon stream has an initial concentration of a contaminant and contains one or more of an oil, a fat, a grease, or any combination thereof. The method also includes combining the heated hydrocarbon stream and a primary solvent in a laminar flow reactor to further heat and produce a hydrocarbon-solvent stream, flowing the hydrocarbon-solvent stream through a cooling unit to produce a cooled hydrocarbon-solvent stream, and introducing the cooled hydrocarbon-solvent stream into a separation unit to produce a scrubbed hydrocarbon stream and a solvent stream. The scrubbed hydrocarbon stream has a final concentration of the contaminant, and the final concentration of the contaminant is less than the initial concentration of the contaminant.

In other embodiments, a method of purifying a hydrocarbon is provided and includes flowing a feedstock hydrocarbon stream through a heating unit to produce a heated hydrocarbon stream, where the feedstock hydrocarbon stream has an initial concentration of a contaminant and contains one or more of an oil, a fat, a grease, or any combination thereof, and then combining the heated hydrocarbon stream and a primary solvent in a laminar flow reactor to further heat and produce a hydrocarbon-solvent stream. The hydrocarbon-solvent stream may be produced by introducing a flow of the heated hydrocarbon stream into a headspace in an upper portion of the laminar flow reactor. The flow of the heated hydrocarbon stream is completely or substantially free of turbulence, and the heated hydrocarbon stream is at a first temperature. The hydrocarbon-solvent stream may further be produced by introducing a flow of the primary solvent into the headspace in the upper portion of the laminar flow reactor, the flow of the primary solvent is completely or substantially free of turbulence, and the primary solvent is at a second temperature greater than the first temperature. The hydrocarbon-solvent stream may be produced by condensing the primary solvent into the heated hydrocarbon stream to produce an intermediate stream, and flowing the intermediate stream through a reaction zone disposed in a lower portion of the laminar flow reactor to produce the hydrocarbon-solvent stream. The method further includes introducing the hydrocarbon-solvent stream into a separation unit to produce a scrubbed hydrocarbon stream and a solvent stream, where the solvent stream contains the contaminant, and flowing the scrubbed hydrocarbon stream through a first finishing unit to produce a purified hydrocarbon stream. The purified hydrocarbon stream has a final concentration of the contaminant, and the final concentration of the contaminant is less than the initial concentration of the contaminant.

In some embodiments, a method of purifying a hydrocarbon is provided and includes flowing a feedstock hydrocarbon stream through a deaerator to degas the feedstock hydrocarbon stream, where the feedstock hydrocarbon stream has an initial concentration of a contaminant and contains soybean oil, corn oil, canola oil, camelina oil, yellow grease, choice white grease, beef tallow, poultry fat, used cooking oil, tall oil, pyrolysis oil, or any combination thereof. The method also includes flowing the degassed feedstock hydrocarbon stream through a heating unit to produce a heated hydrocarbon stream, combining the heated hydrocarbon stream and steam in a laminar flow reactor to produce an aqueous hydrocarbon stream, and flowing the aqueous hydrocarbon stream through a cooling unit to produce a cooled aqueous hydrocarbon stream. The method further includes introducing the cooled aqueous hydrocarbon stream into a vertical extraction column to produce a scrubbed hydrocarbon stream and an aqueous stream by a countercurrent liquid-liquid extraction, where the aqueous stream contains the contaminant, and flowing the scrubbed hydrocarbon stream through a first finishing unit to produce a purified hydrocarbon stream. The purified hydrocarbon stream has a final concentration of the contaminant, and the initial concentration of the contaminant is about 40 times or greater than the final concentration of the contaminant.

In one or more embodiments, a system for purifying a hydrocarbon is provided and contains a deaerator fluidly coupled to and downstream of a feedstock hydrocarbon source, and a heating portion of a recuperator fluidly coupled to and downstream of the deaerator. The feedstock hydrocarbon source is configured to contain a feedstock hydrocarbon having an initial concentration of a contaminant and containing one or more of an oil, a fat, a grease, or any combination thereof. The system also contains an additive source fluidly coupled to and downstream of the deaerator. The additive source is configured to contain an additive containing a hydrolyzing agent, an acid, a base, a salt, a chelating agent, a polar solvent, a non-polar solvent, or any combination thereof. The system also contains a laminar flow reactor containing an upper portion opposite a lower portion, where the upper portion of the laminar flow reactor is fluidly coupled to and downstream of the heating portion of the recuperator. The system also contains a primary solvent source fluidly coupled to and upstream of the upper portion of the laminar flow reactor, a cooling portion of the recuperator fluidly coupled to and downstream of the lower portion of the laminar flow reactor, and a pressure reduction device fluidly coupled to and downstream of the cooling portion of the recuperator. The system further contains a separation unit fluidly coupled to and downstream of the pressure reduction device, where the separation unit contains a scrubbed hydrocarbon stream outlet and a solvent stream outlet. The system may also contain a first finishing unit fluidly coupled to and downstream of the scrubbed hydrocarbon stream outlet, wherein the first finishing unit contains a centrifuge, a cross-flow filtration unit, a coalescer, a decanter, an electrostatic separator, a membrane purifier, or any combination thereof. The first finishing unit contains a purified hydrocarbon stream outlet configured to provide a purified hydrocarbon having a final concentration of the contaminant of at least 10 times, about 40 times, or about 100 times less than the initial concentration of the contaminant. The system may further contain a second finishing unit fluidly coupled to and downstream of the solvent stream outlet, wherein the second finishing unit contains a centrifuge, a cross-flow filtration unit, a coalescer, a decanter, an electrostatic separator, a membrane purifier, or any combination thereof.

### DETAILED DESCRIPTION

Embodiments of the present disclosure generally relate to methods and systems for purifying hydrocarbons, such as feedstock hydrocarbons containing one or more contaminants. In some examples, the feedstock hydrocarbons may be or include one or more oils, fats, greases, or any combination thereof. The feedstock hydrocarbons may be derived from one or more vegetable and/or animal sources. The contaminant may be or include one or more of a halide, phosphorous, one or more phosphorus containing compounds, sulfur, one or more sulfur containing compounds, nitrogen, one or more nitrogen containing compounds, a gum or lecithin, an alkali metal, an alkali earth metal, a transition metal, a metalloid, a heavy metal, or any combination thereof. The methods and systems for purifying hydrocarbons may be used to prepare a purified hydrocarbon product having a contaminant reduced by 10 times, about 40 times, about 100 times, or greater compared to the feedstock hydrocarbons. In some examples, the contaminant is not detectable in the purified hydrocarbon product.

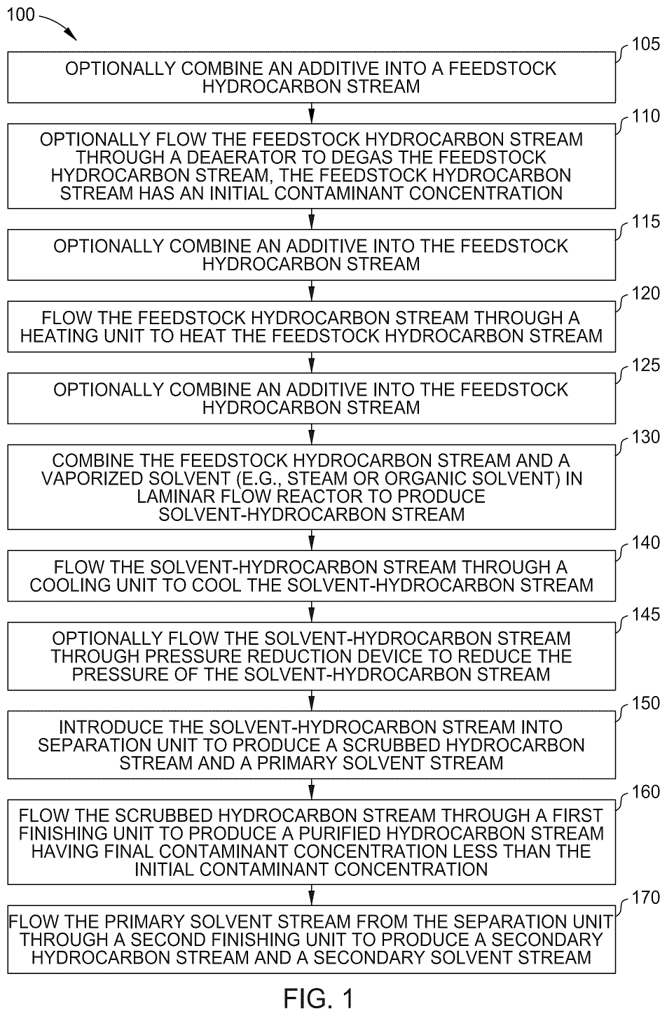

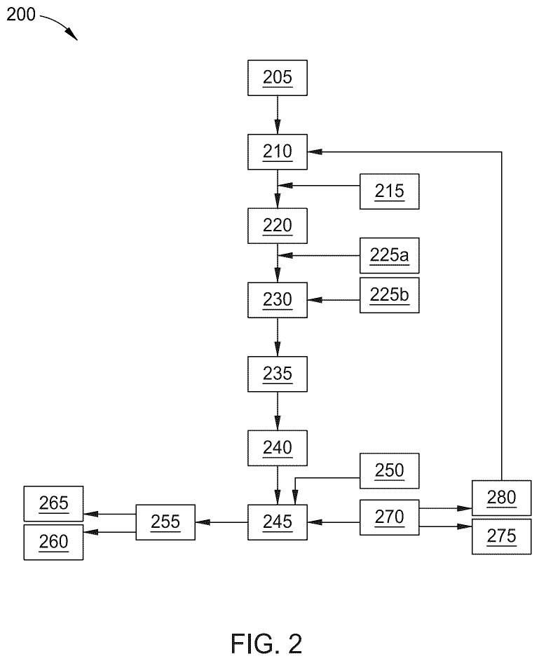

FIG. 1 is a flowchart depicting a process or method 100 for purifying a feedstock hydrocarbon, according to one or more embodiments described and discussed herein. The method 100 includes operations 105-170, as further described and discussed below. The feedstock hydrocarbon stream has an initial contaminant concentration which is reduced and/or removed during operations performed or otherwise conducted throughout the method 100. FIG. 2 depicts a hydrocarbon purification system 200 for processing or otherwise purifying a feedstock hydrocarbon, according to one or more embodiments described and discussed herein. In one or more embodiments, the method 100 may be performed or otherwise conducted with the hydrocarbon purification system 200.

In some embodiments, the method 100 may include optionally combining one or more additives into a feedstock hydrocarbon stream (at operation 105) and optionally flowing the feedstock hydrocarbon stream through a deaerator to degas the feedstock hydrocarbon stream (at operation 110). The method 100 further includes optionally combining one or more additives into the feedstock hydrocarbon stream (at operation 115), flowing the feedstock hydrocarbon stream through one or more heating units to heat the feedstock hydrocarbon stream (at operation 120), and optionally combining one or more additives into the feedstock hydrocarbon stream (at operation 125). The one or more additives may be added into feedstock hydrocarbon stream at any of operations 105, 115, and/or 125. The method 100 further includes combining the feedstock hydrocarbon stream and a primary solvent (e.g., steam, water, and/or one or more organic solvents) in laminar flow reactor to produce a hydrocarbon-solvent stream (at operation 130), and then flowing the hydrocarbon-solvent stream through one or more cooling units to cool the hydrocarbon-solvent stream (at operation 140). The method 100 also includes optionally flowing the hydrocarbon-solvent stream through pressure reduction device to reduce the pressure of the hydrocarbon-solvent stream (at operation 145). Thereafter, the method 100 further includes introducing the hydrocarbon-solvent stream into one or more separation units to produce a scrubbed hydrocarbon stream and a primary or first solvent stream (at operation 150). The method 100 further includes flowing the scrubbed hydrocarbon stream through a first finishing unit to produce a purified hydrocarbon stream having final contaminant concentration of less than the initial contaminant concentration (at operation 160) and flowing the primary or first solvent stream from the separation unit through a second finishing unit to produce a secondary hydrocarbon stream and a secondary solvent stream (at operation 170).

In one or more embodiments, the hydrocarbon purification system 200 for purifying a hydrocarbon is provided and contains a feedstock hydrocarbon source 205. The feedstock hydrocarbon source 205 may contain a feedstock hydrocarbon containing one or more of an oil, a fat, a grease, or any combination thereof, as well as other type of feedstock hydrocarbon discussed further below. The feedstock hydrocarbon has an initial concentration of a contaminant which is reduced and/or removed with method 100.

The hydrocarbon purification system 200 contains a feedstock hydrocarbon source 205 that contains one or more feedstock hydrocarbons and provides the feedstock hydrocarbon stream. In one or more embodiments, the feedstock hydrocarbon may be or contain a non-polar fluid, e.g., petroleum-based feedstocks, such as petroleum crude oil, shale oil, petroleum refinery intermediate streams (such as vacuum tower bottoms (VTB)), pyrolysis oils, recycled plastics, coal liquids, used motor oil, and mixtures thereof. Alternatively, the feedstock hydrocarbon may be or contain a renewable feedstock, such as plant oil. Suitable plant oils include oils of camelina, canola, Carinata, castor, coconut, Jatropha, palm, peanut, Pongamia, soy bean, tung, and/or corn (such as derived from distiller grains), soap stock, waste vegetable oil, yellow grease (from cooking oil), brown grease (from grease traps and wastewater treatment), highly acidic oils (also referred to as acidic oils), animal tallow, algal oil, microbial oil, terpenes and other pine-related byproducts from tall oils, pine oils, or other biosynthetic oils and/or pyrolysis oils (such as derived from pyrolysis, esterification, oligomerization, or polymerization) and mixtures thereof. In some embodiments, the feedstock hydrocarbon may be plant based, animal based, insect based, microbial based, or any combination thereof. In one or more embodiments, the feedstock hydrocarbon may be or contain a food oil which may include one or more plant oils, one or more plant based oils, one or more animal based oils, or any combination thereof. In some embodiments, the feedstock hydrocarbon may be or contain one food oils, purified and/or non-purified food oils, other oils, greases, fats, and/or other substances (e.g., vegetable oils, animal fats, fatty acids, fatty alcohols, and mineral oils), according to one or more embodiments described and discussed herein. In one or more embodiments, the feedstock hydrocarbon may be or contain soybean oil, coconut oil, palm oil, canola oil, corn oil, peanut oil, sunflower oil, cottonseed oil, olive oil, beef fat or lard, pork fat or lard, poultry fat, fish oil, tall oil, pyrolysis oil, or any combination thereof. In one or more examples, the feedstock hydrocarbon may be or contain soybean oil, corn oil, canola oil, camelina oil, yellow grease, choice white grease, beef tallow, poultry fat, used cooking oil, pyrolysis oil, or any combination thereof. In other examples, the feedstock hydrocarbon may be or contain one or more polymeric materials, one or more plastic materials, one or more oligomers, or any combination thereof. Exemplary polymeric materials and/or plastic materials may be or contain one or more of polyethylene terephthalate (PETE), high density polyethylene (HDPE), polyvinyl chloride (PVC), low density polyethylene (LDPE), polypropylene (PP), polystyrene (PS), derivatives thereof, or any combination thereof.

The feedstock hydrocarbon may contain one or more contaminants which are reduced and/or removed by the methods described and discussed herein. Exemplary contaminants contained in the feedstock hydrocarbon may be or contain one or more of a halide (e.g., Cl, F, Br, I), phosphorous, sulfur, nitrogen, a gum or lecithin, a transition metal, an alkali metal, a rare earth metal, other metals, a metalloid, a heavy metal, an inorganic, or any combination thereof. In some examples, the contaminant of total metals may be or contain sodium, potassium, magnesium, calcium, iron, or any combination thereof.

The hydrocarbon purification system 200 may contain a deaerator 210 fluidly coupled to and downstream of the feedstock hydrocarbon source 205. The deaerator 210 may be used to remove or reduce gas dissolved in the feedstock hydrocarbon or other hydrocarbon stream. The feedstock hydrocarbon or other hydrocarbon stream is degassed upon flowing through the deaerator 210. The feedstock hydrocarbon or other hydrocarbon stream may be degassed at any stage of the method 100. In some examples, the feedstock hydrocarbon or other hydrocarbon stream may be degassed at operation 110 of the method 100.

The hydrocarbon purification system 200 contains one or more heating units 220 fluidly coupled to and downstream of the deaerator 210. The heating units 220 may include one or more primary heating units 220 and one or more supplemental heating units 220 fluidly coupled to and downstream of the deaerator 210 and/or fluidly coupled to and upstream of the laminar flow reactor 230. Each of the heating units 220 may be or contain a heating portion of a recuperator, a steam heater, an electric heater, a fuel combustion heater, other heating sources, or any combination thereof. The feedstock hydrocarbon or other hydrocarbon stream may be heated at any stage of the method 100. In some examples, the feedstock hydrocarbon or other hydrocarbon stream may be heated at operation 120 of the method 100.

The hydrocarbon purification system 200 also contains an additive source 215 fluidly coupled to and downstream of the deaerator 210. One or more additives may be added to the feedstock hydrocarbon or other hydrocarbon stream at any portion of the method 100. In some examples, the additives may be added to the feedstock hydrocarbon or other hydrocarbon stream at operation 105, 115, and/or 125 during the method 100. The additive source 215 is configured to contain one or more additives. Exemplary additives may be or contain one or more hydrolyzing agents, one or more acids, one or more bases, one or more salts, one or more chelating agents, one or more polar solvents, one or more non-polar solvents, or any combination thereof. In one or more examples, the additive may be or contain one or more hydrolyzing agents. The hydrolyzing agent may be or contain any chemical capable of hydrolyzing a hydrocarbon, e.g., fat, oil, or grease. For example, the hydrolyzing agent may be or contain acetic acid, ascorbic acid, citric acid, hydrochloric acid, fumaric acid, glucaric acid, gluconic acid, glutamic acid, hydrochloric acid, lactic acid, malic acid, oxalic acid, phosphoric acid, propionic acid, sulfuric acid, tartaric acid, salts thereof, or any combination thereof. As a further example, the hydrolyzing agent may be or contain nitrilotriacetic acid (NTA), ethylenediaminetetraacetic acid (EDTA), sodium hydroxide, potassium hydroxide, lithium hydroxide, ammonium hydroxide, or any combination thereof. Without being bound by theory the additive may react with a triglyceride to separate a fatty acid of the triglyceride from the glycerin backbone, allowing for the purification of the fatty acids in the triglyceride. Additionally, and without being bound by theory, the additive may hydrolyze phospholipids and other contaminants more readily than fatty acids, allowing for selective hydrolyzing of phospholipids at lower temperatures and with shorter residence times than those required for fatty acid splitting of triglycerides, reducing free fatty acid formation in the hydrocarbon purification system 200 including the laminar flow reactor 230. Additionally, and without being bound by theory, the additive may increase a density and/or molecular weight of the aqueous phase, thereby promoting faster separation of the organic phase and the aqueous phase. In one or more embodiments, the feedstock hydrocarbon may include about 50 parts per million (ppm) to about 20,000 ppm of one or more additives, e.g., about 50 ppm to about 1,000 ppm, about 1,000 ppm to about 4,000 ppm, about 4,000 ppm to about 6,000 ppm, about 6,000 ppm to about 8,000 ppm, about 8,000 ppm to about 10,000 ppm, or about 10,000 ppm to about 20,000 ppm.

The hydrocarbon purification system 200 also contains a laminar flow reactor 230 containing an upper portion opposite a lower portion. The upper portion of the laminar flow reactor 230 is fluidly coupled to and downstream of the heating unit 220. In one or more examples, the laminar flow reactor 230 may be or contain a liquid-filled laminar flow reactor and may contain an inflow distributor assembly, an outflow header assembly, a packing assembly, or any combination thereof. For example, the laminar flow reactor 230 may contain an inflow distributor assembly in the upper portion and an outflow header assembly in the lower portion. In other examples, the laminar flow reactor 230 may be or contain a vapor-infused laminar flow reactor and may contain an inflow distributor assembly, a packing assembly, or any combination thereof.

In one or more embodiments, each of a liquid phase within the laminar flow reactor 230 and/or an intermediate stream within the laminar flow reactor 230 and/or a hydrocarbon-solvent stream within the laminar flow reactor 230 may independently persist in laminar flow and a Reynolds number of 2,300 or less. In one or more embodiments, each of a liquid phase within the laminar flow reactor 230 and/or an intermediate stream within the laminar flow reactor 230 and/or a hydrocarbon-solvent stream within the laminar flow reactor 230 may independently have a Reynolds number of about 0, about 10, about 50, about 100, about 200, about 300, about 500, about 600, about 800, about 1,000, about 1,200, about 1,500, about 1,600, about 1,800, less than or about 2,000, less than or about 2,000, less than or about 2,100, less than or about 2,200, less than or about 2250, less than or about 2,290, or 2,300. For example, each of a liquid phase within the laminar flow reactor 230 and/or an intermediate stream within the laminar flow reactor 230 and/or a hydrocarbon-solvent stream within the laminar flow reactor 230 may independently have a Reynolds number in a range from about 0 to 2,300, about 0 to about 2,290, about 0 to about 2,250, about 0 to about 2,200, about 0 to about 2,150, about 0 to about 2,100, about 0 to about 2,050, about 0 to about 2,000, about 0 to less than 2,000, about 0 to about 1,800, about 0 to about 1,600, about 0 to about 1,500, about 0 to about 1,200, about 0 to about 1,000, about 0 to about 800, about 0 to about 600, about 0 to about 500, about 0 to about 200, about 0 to about 100, about 500 to 2,300, about 500 to about 2,290, about 500 to about 2,250, about 500 to about 2,200, about 500 to about 2,150, about 500 to about 2,100, about 500 to about 2,050, about 500 to about 2,000, about 500 to less than 2,000, about 500 to about 1,800, about 500 to about 1,600, about 500 to about 1,500, about 500 to about 1,200, about 500 to about 1,000, about 500 to about 800, about 500 to about 600, about 1,000 to 2,300, about 1,000 to about 2,290, about 1,000 to about 2,250, about 1,000 to about 2,200, about 1,000 to about 2,150, about 1,000 to about 2,100, about 1,000 to about 2,050, about 1,000 to about 2,000, about 1,000 to less than 2,000, about 1,000 to about 1,800, about 1,000 to about 1,600, about 1,000 to about 1,500, or about 1,000 to about 1,200. Not to be bound by theory, it is believed that a liquid with a Reynolds number of greater 2,300 has a turbulent flow instead of a laminar flow.

The hydrocarbon purification system 200 also contains one, two, or more primary solvent source 225a, 225b fluidly coupled to and upstream of the upper portion of the laminar flow reactor 230. In one or more examples, each of the primary solvent source 225a, 225b may independently be or contain a water and/or steam source configured to store and/or disperse water and/or steam. In other examples, each of the primary solvent source 225a, 225b may independently be or contain a solvent source and be configured to store and/or disperse one or more vapor solvents and/or liquid solvents. The solvent may be or contain one or more of a polar protic solvent, a polar aprotic solvent, a nonpolar hydrocarbon solvent, a nonpolar ether solvent, a nonpolar chlorocarbon solvent, or any combination thereof. For example, the solvent may be or include one or more alcohols, one or more ketones, one or more aromatics, one or more alky sulfoxides, one or more furans, or any combination thereof. Exemplary solvents may be water, methanol, ethanol, propanol, butanol, glycerol, acetone, methyl ethyl ketone, benzene, toluene, xylene, dimethyl sulfoxide (DMSO), tetrahydrofuran, supercritical carbon dioxide, or any combination thereof. In one or more examples, the feedstock hydrocarbon stream and a primary solvent (e.g., water, steam, and/or one or more organic solvents) may be combined in laminar flow reactor to produce a hydrocarbon-solvent stream at operation 130 of the method 100.

The hydrocarbon purification system 200 contains a cooling unit 235 fluidly coupled to and downstream of the lower portion of the laminar flow reactor 230. The cooling unit 235 may be or contain a cooling portion of the recuperator, a coolant circulation system, a refrigeration system, or other cooling system. In one or more examples, the hydrocarbon-solvent stream may be introduced and flowed through one or more cooling units to cool the hydrocarbon-solvent stream at operation 140 of the method 100.

The hydrocarbon purification system 200 may also contain one or more pressure reduction devices 240 fluidly coupled to and downstream of the cooling unit 235. The pressure reduction device 240 may be or contain a low-shear pressure reduction device, a cyclonic pressure reduction device, a multi-stage pressure reduction device, or any combination thereof. In one or more examples, the pressure reduction device 240 is a cyclonic pressure reduction device, such as the Typhoon® Valve System, commercially available from the Mokveld Company. In one or more examples, the hydrocarbon-solvent stream or the cooled hydrocarbon-solvent stream may be introduced and flowed through one or more pressure reduction device to reduce the pressure of the hydrocarbon-solvent stream or the cooled hydrocarbon-solvent stream at operation 145 of the method 100.

In one or more examples, the cooled hydrocarbon-solvent stream may be flowed through the pressure reduction device 240 such that the cooled hydrocarbon-solvent stream enters the pressure reduction device 240 at a first pressure and exits the pressure reduction device 240 at a second pressure less than the first pressure. For example, the cooled hydrocarbon-solvent stream may be at a first pressure entering the pressure reduction device 240 and at a second pressure when exiting the pressure reduction device 240. In some examples, the first pressure may be at least 10 times about 20 times, about 50 times, about 100 times, or greater than the second pressure. In other examples, the second pressure is at least one half of the value of the first pressure.

The first pressure may be in a range from about 500 pounds per square inch (psi), greater than 500 psi, about 550 psi, about 600 psi, or about 800 psi to about 1,000 psi, about 1,200 psi, about 1,500 psi, about 1,800 psi, about 2,000 psi, or greater. For example, the first pressure may be in a range from about 500 psi to about 2,000 psi, about 500 psi to about 1,800 psi, about 500 psi to about 1,500 psi, about 500 psi to about 1,200 psi, about 500 psi to about 1,000 psi, about 500 psi to about 800 psi, about 500 psi to about 600 psi, about 800 psi to about 2,000 psi, about 800 psi to about 1,800 psi, about 800 psi to about 1,500 psi, about 800 psi to about 1,200 psi, about 800 psi to about 1,000 psi, about 1,000 psi to about 2,000 psi, about 1,000 psi to about 1,800 psi, about 1,000 psi to about 1,500 psi, or about 1,000 psi to about 1,200 psi.

The second pressure may be in a range from about 1 psi, about 5 psi, about 10 psi, about 20 psi, about 50 psi, or about 100 psi to about 150 psi, about 200 psi, about 250 psi, about 300 psi, about 350 psi, about 400 psi, about 450 psi, less than 500 psi, about 500 psi. For example, the second pressure may be in a range from about 1 psi to less than or about 500 psi, about 1 psi to about 400 psi, about 1 psi to about 350 psi, about 1 psi to about 300 psi, about 1 psi to about 250 psi, about 1 psi to about 200 psi, about 1 psi to about 150 psi, about 1 psi to about 100 psi, about 1 psi to about 80 psi, about 1 psi to about 50 psi, about 1 psi to about 10 psi, about 50 psi to less than or about 500 psi, about 50 psi to about 400 psi, about 50 psi to about 350 psi, about 50 psi to about 300 psi, about 50 psi to about 250 psi, about 50 psi to about 200 psi, about 50 psi to about 150 psi, about 50 psi to about 100 psi, about 50 psi to about 80 psi, about 50 psi to about 60 psi, about 100 psi to less than or about 500 psi, about 100 psi to about 400 psi, about 100 psi to about 350 psi, about 100 psi to about 300 psi, about 100 psi to about 250 psi, about 100 psi to about 200 psi, about 100 psi to about 150 psi, or about 100 psi to about 120 psi.

In one or more examples, the first pressure may be in a range about 500 psi to about 1,500 psi, and the second pressure may be in a range from about 1 psi to about 500 psi. In other examples, the first pressure may be in a range greater than 500 psi to about 1,500 psi, and the second pressure may be in a range from about 1 psi to about 500 psi. In some examples, the first pressure may be in a range about 500 psi to about 1,500 psi, and the second pressure may be in a range from about 1 psi to less than 500 psi.

The hydrocarbon purification system 200 contains a separation unit 245 fluidly coupled to and downstream of the pressure reduction device 240. The separation unit 245 may be or contain one or more extraction columns, one or more centrifuges, one or more cross-flow filtration units, one or more coalescers, one or more decanters, one or more electrostatic separators, one or more membrane purifiers, or any combination thereof. In one or more embodiments, the separation unit 245 may be any of the extraction columns and/or other units and systems described and discussed in U.S. Pub. No. 2024/0150660, which is herein incorporated by reference in its entirety.

In one or more examples, the separation unit 245 contains a vertical extraction column. One or more solvent or water sources 250 may be fluidly coupled to and upstream of the separation unit 245. The solvent or water source 250 may supply and otherwise introduce one or more solvents or water into the separation unit 245. The separation unit 245 contains a scrubbed hydrocarbon stream outlet and a solvent stream outlet. In one or more examples, a scrubbed hydrocarbon stream flowing from the scrubbed hydrocarbon stream outlet of the separation unit 245 contains a final concentration of the contaminant of at least 10 times, about 40 times, or about 100 times less than the initial concentration of the contaminant.

In one or more examples, the separation unit 245 is a vertical extraction column containing an upper portion opposite a lower portion, an upper inlet in the upper portion configured to receive a water or solvent stream, and a lower inlet in the lower portion coupled to and downstream of the pressure reduction device 240. The lower inlet may be configured to receive a cooled hydrocarbon-solvent stream. A central region of the vertical extraction column is disposed between the upper and lower portions and configured to perform a countercurrent liquid-liquid extraction by flowing the cooled hydrocarbon-solvent stream toward the upper portion of the vertical extraction column and flowing the solvent or water stream toward the lower portion of the vertical extraction column. The scrubbed hydrocarbon stream outlet may be disposed in the upper portion of the vertical extraction column and a solvent stream outlet may be disposed in the lower portion of the vertical extraction column. In some examples, the central region of the vertical extraction column contains one or more packing assemblies. In one or more examples, the hydrocarbon-solvent stream may be introduced and flowed into one or more separation units to produce a scrubbed hydrocarbon stream and a primary or first solvent stream at operation 150 of the method 100.

In one or more embodiments, the solvent stream is an aqueous stream and is diverted or otherwise flowed from the separation unit 245 to a mixer (not shown). The solvent stream or aqueous stream is concentrated and/or dried and then blended with a product in the mixer. The product may be or contain one or more of a processed grain, vegetable meal, fruit meal, protein meal, meat, stover, hay, forage, or any combination thereof. The mixer may be or contain one or more of a tumbler mixer, paddle mixer, cone mixer, screw mixer, or any combination thereof.

The hydrocarbon purification system 200 may also contain one, two, or more finishing units, such as finishing units 255, 270. For example, the first finishing unit 255 may be fluidly coupled to and downstream of the scrubbed hydrocarbon stream outlet of the separation unit 245. The first finishing unit 255 may be or contain a centrifuge, a cross-flow filtration unit, a coalescer, a decanter, an electrostatic separator, a membrane purifier, or any combination thereof.

The first finishing unit 255 contains a purified hydrocarbon stream outlet configured to provide a purified hydrocarbon stream 265 having a final concentration of the contaminant of at least 10 times, about 40 times, or about 100 times less than the initial concentration of the contaminant. The first finishing unit 255 also contains a water-solvent waste stream 260. In one or more examples, the scrubbed hydrocarbon stream may be flowed through a first finishing unit to produce a purified hydrocarbon stream having final contaminant concentration having a value less than the initial contaminant concentration at operation 160 of the method 100.

In one or more embodiments, the initial concentration of the contaminant in the feedstock hydrocarbon is about 10 times, about 20 times, about 40 times, about 50 times, about 100 times, about 120 times, about 150 times, about 200 times, about 300 times, about 500 times, about 1,000 times, or greater than the final concentration of the contaminant of the purified or scrubbed hydrocarbon stream. In some examples, the initial contaminant concentration of the feedstock hydrocarbon is about 40 ppm, about 100 ppm, about 200 ppm, about 300 ppm, about 500 ppm, about 1,000 ppm, or greater, and the final concentration of the total metals is less than 20 ppm, less than 10 ppm, less than 5 ppm, less than 2 ppm, or less than 1 ppm in the purified or scrubbed hydrocarbon stream. In one or more embodiments, the initial concentration of the total metals is 40 ppm or greater, and the final concentration of the total metals in the feedstock hydrocarbon is less than 5 ppm, less than 2 ppm, or less than 1 ppm in the purified or scrubbed hydrocarbon stream. In other examples, the contaminant is phosphorus, the initial concentration of the phosphorous is 100 ppm or greater in the feedstock hydrocarbon, and the final concentration of the phosphorus is less than 5 ppm, such as less than 2 ppm, or less than 1 ppm in the purified or scrubbed hydrocarbon stream.

In one or more examples, the contaminant may be or include phosphorous, sulfur, nitrogen, total metals, or a combination thereof within the purified or scrubbed hydrocarbon stream. The final concentration of the contaminant may be less than 100 ppm, less than 50 ppm, less than 20 ppm, less than 10 ppm, less than 5 ppm, less than 1 ppm, or less than 0.1 ppm, or lower within the purified or scrubbed hydrocarbon stream. For example, the final concentration of the any of the contaminant may be non-detectable (ND) within the purified or scrubbed hydrocarbon stream. A non-detectable amount is based on the sensitivity of the instrument used to detect the concentration, and in some examples, the instrument may have a sensitivity of about 0.1 ppm.

The second finishing unit 270 may be fluidly coupled to and downstream of the solvent stream outlet. The second finishing unit 270 contains a centrifuge, a cross-flow filtration unit, a coalescer, a decanter, an electrostatic separator, a membrane purifier, or any combination thereof. The second finishing unit 270 contains a water-solvent waste stream 275 and a hydrocarbon stream 280. The water-solvent waste stream 275 may be further processed in a water-solvent purification system. The hydrocarbon stream 280 may be recycled back into the hydrocarbon purification system 200, such as being transferred to the feedstock hydrocarbon source 205, the deaerator 210, or components of the hydrocarbon purification system 200. In one or more examples, the primary or first solvent stream may be flowed from the separation unit through a second finishing unit to produce a secondary hydrocarbon stream and a secondary solvent stream at operation 170 of the method 100.

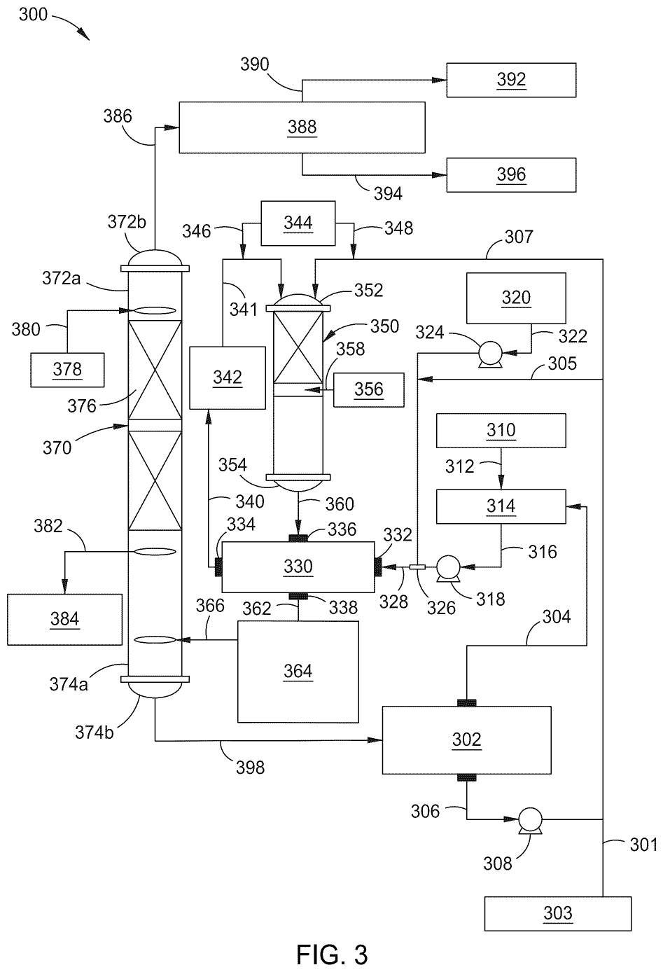

FIG. 3 depicts a hydrocarbon purification system 300 for purifying a feedstock hydrocarbon, according to one or more embodiments described and discussed herein. In one or more embodiments, the hydrocarbon purification system 300 for purifying a hydrocarbon is provided and contains a feedstock hydrocarbon source 310. The feedstock hydrocarbon source 310 contains a feedstock hydrocarbon containing one or more of an oil, a fat, a grease, or any combination thereof, as well as other type of feedstock hydrocarbon discussed further below. The feedstock hydrocarbon has an initial concentration of a contaminant which is reduced and/or removed by the method 100 and/or with the processes and methods described and discussed herein.

In one or more embodiments, the feedstock hydrocarbon may be or contain a non-polar fluid, e.g., petroleum-based feedstocks, such as petroleum crude oil, shale oil, petroleum refinery intermediate streams (such as vacuum tower bottoms (VTB)), pyrolysis oils, recycled plastics, coal liquids, used motor oil, and mixtures thereof. Alternatively, the feedstock hydrocarbon may be or contain a renewable feedstock, such as plant oil. Suitable plant oils include oils of camelina, canola, Carinata, castor, coconut, Jatropha, palm, peanut, Pongamia, soy bean, tung, and/or corn (such as derived from distiller grains), soap stock, waste vegetable oil, yellow grease (from cooking oil), brown grease (from grease traps and wastewater treatment), highly acidic oils (also referred to as acidic oils), animal tallow, algal oil, microbial oil, terpenes and other pine-related byproducts from tall oils, pine oils, or other biosynthetic oils and/or pyrolysis oils (such as derived from pyrolysis, esterification, oligomerization, or polymerization) and mixtures thereof. In some embodiments, the feedstock hydrocarbon may be plant based, animal based, insect based, microbial based, or any combination thereof. In one or more embodiments, the feedstock hydrocarbon may be or contain a food oil which may include one or more plant oils, one or more plant based oils, one or more animal based oils, or any combination thereof. In some embodiments, the feedstock hydrocarbon may be or contain one food oils, purified and/or non-purified food oils, other oils, greases, fats, and/or other substances (e.g., vegetable oils, animal fats, fatty acids, fatty alcohols, and mineral oils), according to one or more embodiments described and discussed herein. In one or more embodiments, the feedstock hydrocarbon may be or contain soybean oil, coconut oil, palm oil, canola oil, corn oil, peanut oil, sunflower oil, cottonseed oil, olive oil, beef fat or lard, pork fat or lard, poultry fat, fish oil, tall oil, pyrolysis oil, or any combination thereof. In one or more examples, the feedstock hydrocarbon may be or contain soybean oil, corn oil, canola oil, camelina oil, yellow grease, choice white grease, beef tallow, poultry fat, used cooking oil, pyrolysis oil, or any combination thereof. In other examples, the feedstock hydrocarbon may be or contain one or more polymeric materials, one or more plastic materials, one or more oligomers, or any combination thereof. Exemplary polymeric materials and/or plastic materials may be or contain one or more of polyethylene terephthalate (PETE), high density polyethylene (HDPE), polyvinyl chloride (PVC), low density polyethylene (LDPE), polypropylene (PP), polystyrene (PS), derivatives thereof, or any combination thereof.

The feedstock hydrocarbon may contain one or more contaminants which are reduced and/or removed by the methods described and discussed herein. Exemplary contaminants contained in the feedstock hydrocarbon may be or contain one or more of a halide (e.g., Cl, F, Br, I), phosphorous, sulfur, nitrogen, a gum or lecithin, a transition metal, an alkali metal, a rare earth metal, other metals, a metalloid, a heavy metal, an inorganic, or any combination thereof. In some examples, the contaminant of total metals may be or contain sodium, potassium, magnesium, calcium, iron, or any combination thereof.

The feedstock hydrocarbon is transferred by line 312 to a deaerator 314 fluidly coupled to and downstream of the feedstock hydrocarbon source 310. The deaerator 314 may be used to degas the feedstock hydrocarbon. A pump 318 may be used to transfer or flow the feedstock hydrocarbon through the hydrocarbon purification system 300. The feedstock hydrocarbon is transferred via line 316 to a connection point 326 where the feedstock hydrocarbon may be combined with one or more additives. The additive is delivered from an additive source 320 which is fluidly coupled to and upstream of the connection point 326 via line 322. A pump 324 may be used to transfer or flow the additive via line 322. The additive source 320 contains one or more additives may be or contain one or more hydrolyzing agents, one or more acids, one or more bases, one or more salts, one or more chelating agents, one or more polar solvents, one or more non-polar solvents, or any combination thereof.

The feedstock hydrocarbon containing the additive is transferred from the connection point 326 via line 328 to one or more heating units.

The hydrocarbon purification system 300 contains one or more heating units fluidly coupled to and downstream of the feedstock hydrocarbon source 310, the additive source 320, and/or the deaerator 314. The heating units may include one or more primary heating units and one or more supplemental heating units fluidly coupled to and downstream of the deaerator 314 and/or fluidly coupled to and upstream of a laminar flow reactor 350. A heating unit may be or contain a heating portion of a recuperator 330 which extends between inlet 332 and outlet 334. The feedstock hydrocarbon containing the additive is transferred via line 328, into inlet 332 and out of the outlet 334, while flowing through and being heated in the heating portion of the recuperator 330. The heated feedstock hydrocarbon may flow via line 340 through a secondary heater, such as a steam heater 342. Each of the heating portion of a recuperator 330 and/or the steam heater 342 may be substituted with other types of heating units including an electric heater, a fuel combustion heater, other heating sources, or any combination thereof.

The heated feedstock hydrocarbon may be flowed via line 341 to the laminar flow reactor 350 containing an upper portion 352 opposite a lower portion 354. The feedstock hydrocarbon may be introduced into the upper portion by line 341. A primary solvent source 344 via line 346 may be fluidly coupled to line 341 and configured to introduce one or more solvents (e.g., water, steam, organic solvent, organic vapor) into the heated feedstock hydrocarbon in line 341 prior to entering into the laminar flow reactor 350. In some examples, primary solvent source 344 via line 348 may be fluidly coupled to line 307 and configured to introduce one or more solvents (e.g., water, steam, organic solvent, organic vapor) into a recycled water or solvent in line 307 prior to entering into the laminar flow reactor 350.

In one or more embodiments, the primary solvent (e.g., steam or vaporized solvent) from the primary solvent source 344 may be introduced into the laminar flow reactor 350 through one or more injection devices disposed at line 346 and/or line 348. For example, each of line 346 and line 348 may independently be or contain one or more injection devices in fluid communication with the laminar flow reactor 350. The injection device may be or contain one or more distributors, valves, nozzles, other injecting devices, or any combination thereof. The primary solvent may independently have a pressure drop across each of the injection device at line 346 and/or the injection device at line 348 in a range from about 0.0001 psi, about 0.005 psi, about 0.001 psi, about 0.05 psi, about 0.01 psi, about 0.5 psi, or about 0.1 psi to about 1 psi, about 5 psi, about 10 psi, about 20 psi, about 30 psi, about 40 psi, about 50 psi, about 60 psi, about 70 psi, about 80 psi, or greater. For example, the primary solvent may independently have a pressure drop across the injection device at line 346 and/or the injection device at line 348 in a range from about 0.0001 psi to about 80 psi, about 0.0001 psi to about 60 psi, about 0.0001 psi to about 40 psi, about 0.0001 psi to about 20 psi, about 0.0001 psi to about 10 psi, about 0.0001 psi to about 5 psi, about 0.0001 psi to about 1 psi, about 0.0001 psi to about 0.1 psi, about 0.0001 psi to about 0.01 psi, about 0.0001 psi to about 0.001 psi, about 0.0001 psi to about 0.0005 psi, about 0.001 psi to about 80 psi, about 0.001 psi to about 60 psi, about 0.001 psi to about 40 psi, about 0.001 psi to about 20 psi, about 0.001 psi to about 10 psi, about 0.001 psi to about 5 psi, about 0.001 psi to about 1 psi, about 0.001 psi to about 0.1 psi, about 0.001 psi to about 0.01 psi, about 0.01 psi to about 80 psi, about 0.01 psi to about 60 psi, about 0.01 psi to about 40 psi, about 0.01 psi to about 20 psi, about 0.01 psi to about 10 psi, about 0.01 psi to about 5 psi, about 0.01 psi to about 1 psi, or about 0.01 psi to about 0.1 psi.

In one or more examples, the laminar flow reactor 350 may be or contain a liquid-filled laminar flow reactor and may contain an inflow distributor assembly, an outflow header assembly, a packing assembly, or any combination thereof. For example, the laminar flow reactor 350 may contain an inflow distributor assembly in the upper portion and an outflow header assembly in the lower portion. In other examples, the laminar flow reactor 350 may be or contain a vapor-infused laminar flow reactor and may contain an inflow distributor assembly, a packing assembly, or any combination thereof.

A primary solvent source 356 via line 358 may be fluidly coupled to the laminar flow reactor 350 and configured to introduce one or more solvents (e.g., water, steam, organic solvent, organic vapor) into the feedstock hydrocarbon in the laminar flow reactor 350 to produce a hydrocarbon-solvent stream. In some examples, the primary solvent source 356 via line 358 may be fluidly coupled to the laminar flow reactor 350 at or by a middle portion disposed between the upper portion 352 and the lower portion 354, as depicted in FIG. 3. In other examples, the primary solvent source 356 via line 358 may be fluidly coupled to the laminar flow reactor 350 at the upper portion 352 and/or at the lower portion 354 (not shown).

In one or more examples, the primary solvent source 356 may be or contain a steam source configured to store and/or disperse water and/or steam. In other examples, the primary solvent source 356 may be or contain a solvent source and be configured to store and/or disperse one or more solvents. The solvent may be or contain one or more of a polar protic solvent, a polar aprotic solvent, a nonpolar hydrocarbon solvent, a nonpolar ether solvent, a nonpolar chlorocarbon solvent, or any combination thereof. For example, the solvent may be or include one or more alcohols, one or more ketones, one or more aromatics, one or more alky sulfoxides, one or more furans, or any combination thereof. Exemplary solvents may be water, methanol, ethanol, propanol, butanol, glycerol, acetone, methyl ethyl ketone, benzene, toluene, xylene, dimethyl sulfoxide (DMSO), tetrahydrofuran, supercritical carbon dioxide, or any combination thereof.

In one or more embodiments, each of a liquid phase within the laminar flow reactor 350 and/or an intermediate stream within the laminar flow reactor 350 and/or a hydrocarbon-solvent stream within the laminar flow reactor 350 may independently persist in laminar flow and a Reynolds number of 2,300 or less. In one or more embodiments, each of a liquid phase within the laminar flow reactor 350 and/or an intermediate stream within the laminar flow reactor 350 and/or a hydrocarbon-solvent stream within the laminar flow reactor 350 may independently have a Reynolds number of about 0, about 10, about 50, about 100, about 200, about 300, about 500, about 600, about 800, about 1,000, about 1,200, about 1,500, about 1,600, about 1,800, less than or about 2,000, less than or about 2,000, less than or about 2,100, less than or about 2,200, less than or about 2250, less than or about 2,290, or 2,300. For example, each of a liquid phase within the laminar flow reactor 350 and/or an intermediate stream within the laminar flow reactor 350 and/or a hydrocarbon-solvent stream within the laminar flow reactor 350 may independently have a Reynolds number in a range from about 0 to 2,300, about 0 to about 2,290, about 0 to about 2,250, about 0 to about 2,200, about 0 to about 2,150, about 0 to about 2,100, about 0 to about 2,050, about 0 to about 2,000, about 0 to less than 2,000, about 0 to about 1,800, about 0 to about 1,600, about 0 to about 1,500, about 0 to about 1,200, about 0 to about 1,000, about 0 to about 800, about 0 to about 600, about 0 to about 500, about 0 to about 200, about 0 to about 100, about 500 to 2,300, about 500 to about 2,290, about 500 to about 2,250, about 500 to about 2,200, about 500 to about 2,150, about 500 to about 2,100, about 500 to about 2,050, about 500 to about 2,000, about 500 to less than 2,000, about 500 to about 1,800, about 500 to about 1,600, about 500 to about 1,500, about 500 to about 1,200, about 500 to about 1,000, about 500 to about 800, about 500 to about 600, about 1,000 to 2,300, about 1,000 to about 2,290, about 1,000 to about 2,250, about 1,000 to about 2,200, about 1,000 to about 2,150, about 1,000 to about 2,100, about 1,000 to about 2,050, about 1,000 to about 2,000, about 1,000 to less than 2,000, about 1,000 to about 1,800, about 1,000 to about 1,600, about 1,000 to about 1,500, or about 1,000 to about 1,200. Not to be bound by theory, it is believed that a liquid with a Reynolds number of greater 2,300 has a turbulent flow instead of a laminar flow.

The hydrocarbon-solvent stream via line 360 may be flowed from the laminar flow reactor 350 and through one or more cooling units. The cooling unit is fluidly coupled to and downstream of the lower portion 354 of the laminar flow reactor 350. The hydrocarbon-solvent stream via line 360 may be flowed into a cooling portion of the recuperator 330 which extends between inlet 336 and outlet 338. The hydrocarbon-solvent stream is transferred via line 360, into inlet 336 and out of the outlet 338, while flowing through and being cooled in the cooling portion of the recuperator 330. The cooling unit may be substituted with other types of cooling units including air cooled and/or a circulation cooling systems.

The cooled hydrocarbon-solvent stream may be flowed via line 362 into and through one or more pressure reduction devices 364. The pressure reduction device 364 is fluidly coupled to and downstream of the cooling unit 235 via line 362 and fluidly coupled to and upstream of a separation unit 370 via line 366. The pressure reduction device 364 may be or contain a low-shear pressure reduction device, a cyclonic pressure reduction device, a multi-stage pressure reduction device, or any combination thereof. The pressure reduction device 364 may decrease the pressure of the hydrocarbon-solvent stream by about 10 times, about 20 times, about 50 times, about 100 times, or greater between line 362 and line 366. The first pressure of the hydrocarbon-solvent stream at line 362 may be in a range from about 500 psi to about 1,500 psi, and the second pressure of the hydrocarbon-solvent stream at line 366 is in a range from about 1 psi to about 500 psi, where the second pressure is at least one half of the value of the first pressure. In one or more examples, the pressure reduction device 364 is a cyclonic pressure reduction device, such as the Typhoon® Valve System, commercially available from the Mokveld Company.

In one or more examples, the cooled hydrocarbon-solvent stream may be flowed through the pressure reduction device 364 such that the cooled hydrocarbon-solvent stream enters the pressure reduction device 364 at a first pressure and exits the pressure reduction device 364 at a second pressure less than the first pressure. For example, the cooled hydrocarbon-solvent stream may be at a first pressure entering the pressure reduction device 364 and at a second pressure when exiting the pressure reduction device 364. In some examples, the first pressure may be at least 10 times, about 20 times, or greater than the second pressure. In other examples, the second pressure is at least one half of the value of the first pressure.

The first pressure may be in a range from about 500 psi, greater than 500 psi, about 550 psi, about 600 psi, or about 800 psi to about 1,000 psi, about 1,200 psi, about 1,500 psi, about 1,800 psi, about 2,000 psi, or greater. For example, the first pressure may be in a range from about 500 psi to about 2,000 psi, about 500 psi to about 1,800 psi, about 500 psi to about 1,500 psi, about 500 psi to about 1,200 psi, about 500 psi to about 1,000 psi, about 500 psi to about 800 psi, about 500 psi to about 600 psi, about 800 psi to about 2,000 psi, about 800 psi to about 1,800 psi, about 800 psi to about 1,500 psi, about 800 psi to about 1,200 psi, about 800 psi to about 1,000 psi, about 1,000 psi to about 2,000 psi, about 1,000 psi to about 1,800 psi, about 1,000 psi to about 1,500 psi, or about 1,000 psi to about 1,200 psi.

The second pressure may be in a range from about 1 psi, about 5 psi, about 10 psi, about 20 psi, about 50 psi, or about 100 psi to about 150 psi, about 200 psi, about 250 psi, about 300 psi, about 350 psi, about 400 psi, about 450 psi, less than 500 psi, about 500 psi. For example, the second pressure may be in a range from about 1 psi to less than or about 500 psi, about 1 psi to about 400 psi, about 1 psi to about 350 psi, about 1 psi to about 300 psi, about 1 psi to about 250 psi, about 1 psi to about 200 psi, about 1 psi to about 150 psi, about 1 psi to about 100 psi, about 1 psi to about 80 psi, about 1 psi to about 50 psi, about 1 psi to about 10 psi, about 50 psi to less than or about 500 psi, about 50 psi to about 400 psi, about 50 psi to about 350 psi, about 50 psi to about 300 psi, about 50 psi to about 250 psi, about 50 psi to about 200 psi, about 50 psi to about 150 psi, about 50 psi to about 100 psi, about 50 psi to about 80 psi, about 50 psi to about 60 psi, about 100 psi to less than or about 500 psi, about 100 psi to about 400 psi, about 100 psi to about 350 psi, about 100 psi to about 300 psi, about 100 psi to about 250 psi, about 100 psi to about 200 psi, about 100 psi to about 150 psi, or about 100 psi to about 120 psi.

In one or more examples, the first pressure may be in a range about 500 psi to about 1,500 psi, and the second pressure may be in a range from about 1 psi to about 500 psi. In other examples, the first pressure may be in a range greater than 500 psi to about 1,500 psi, and the second pressure may be in a range from about 1 psi to about 500 psi. In some examples, the first pressure may be in a range about 500 psi to about 1,500 psi, and the second pressure may be in a range from about 1 psi to less than 500 psi.

The separation unit 370 is fluidly coupled to and downstream of the pressure reduction device 364 via line 366. The separation unit 370, as depicted in FIG. 3, is a vertical extraction column. In other embodiments, the separation unit 370 may be a horizontal extraction column, a centrifuge, a cross-flow filtration unit, a coalescer, a decanter, an electrostatic separator, a membrane purifier, or any combination thereof. In one or more embodiments, the separation unit 370 may be any of the extraction columns and/or other units and systems described and discussed in U.S. Pub. No. 2024/0150660, which is herein incorporated by reference in its entirety.

One or more solvent or water sources 378 via line 380 may be fluidly coupled to and upstream of the separation unit 370. The solvent or water source 378 may supply and otherwise introduce one or more solvents or water into the separation unit 370. The separation unit 370 contains a scrubbed hydrocarbon stream outlet via line 386 and a solvent stream outlet via line 398. In one or more examples, a scrubbed hydrocarbon stream flowing from the scrubbed hydrocarbon stream outlet via line 380 of the separation unit 370 contains a final concentration of the contaminant of at least 10 times, about 40 times, or about 100 times less than the initial concentration of the contaminant.

In one or more embodiments, the initial concentration of the contaminant in the feedstock hydrocarbon is about 10 times, about 20 times, about 40 times, about 50 times, about 100 times, about 120 times, about 150 times, about 300 times, about 500 times, about 1,000 times, or greater than the final concentration of the contaminant of the purified or scrubbed hydrocarbon stream. In some examples, the initial contaminant concentration of the feedstock hydrocarbon is about 40 ppm, about 100 ppm, about 200 ppm, about 300 ppm, about 500 ppm, about 1,000 ppm, or greater, and the final concentration of the total metals is less than 20 ppm, less than 10 ppm, less than 5 ppm, less than 2 ppm, or less than 1 ppm in the purified or scrubbed hydrocarbon stream. In one or more embodiments, the initial concentration of the total metals is 40 ppm or greater, and the final concentration of the total metals in the feedstock hydrocarbon is less than 5 ppm, less than 2 ppm, or less than 1 ppm in the purified or scrubbed hydrocarbon stream. In other examples, the contaminant is phosphorus, the initial concentration of the phosphorous is 100 ppm or greater in the feedstock hydrocarbon, and the final concentration of the phosphorus is less than 5 ppm, such as less than 2 ppm, or less than 1 ppm in the purified or scrubbed hydrocarbon stream.

In one or more examples, the contaminant may be or include phosphorous, sulfur, nitrogen, total metals, or a combination thereof within the purified or scrubbed hydrocarbon stream. The final concentration of the contaminant may be less than 100 ppm, less than 50 ppm, less than 20 ppm, less than 10 ppm, less than 5 ppm, less than 1 ppm, or less than 0.1 ppm, or lower within the purified or scrubbed hydrocarbon stream. For example, the final concentration of the any of the contaminant may be non-detectable (ND) within the purified or scrubbed hydrocarbon stream. A non-detectable amount is based on the sensitivity of the instrument used to detect the concentration, and in some examples, the instrument may have a sensitivity of about 0.1 ppm.

In one or more examples, the separation unit 370 is a vertical extraction column containing an upper portion 372b opposite a lower portion 374b, an upper inlet via line 380 in the upper portion 372a configured to receive a solvent or water stream, and a lower inlet via line 366 in the lower portion 374a coupled to and downstream of the pressure reduction device 364. The lower inlet via line 366 may be configured to receive a cooled hydrocarbon-solvent stream. A central region of the vertical extraction column 370 is disposed between the upper and lower portions 372b, 374b and configured to perform a countercurrent liquid-liquid extraction by flowing the cooled hydrocarbon-solvent stream toward the upper portion 372a of the vertical extraction column 370 and flowing the solvent or water stream toward the lower portion 374b of the vertical extraction column 370. The scrubbed hydrocarbon stream outlet via line 386 may be disposed in the upper portion 372b of the vertical extraction column 370. A solvent stream outlet via line 398 may be disposed in the lower portion 472b of the vertical extraction column 370. The solvent stream outlet via line 398 may transport a water-solvent waste stream away from the vertical extraction column 370. In some examples, the central region of the vertical extraction column 370 contains one or more packing assemblies 376. In some examples, a rag discharge unit 384 via line 382 is fluidly coupled to and downstream of a lower portion of the central region of the vertical extraction column 370. The rag discharge unit 384 is configured to receive a rag composition containing a mixture of oil, water, solids, and interfacially active components.

One or more solvent or water sources 378 via line 380 may be fluidly coupled to and upstream of the separation unit 370. The solvent or water source 378 may supply and otherwise introduce one or more solvents or water into the separation unit 370. The separation unit 370 contains a scrubbed hydrocarbon stream outlet via line 386 and a solvent stream outlet via line 398. In one or more examples, a scrubbed hydrocarbon stream flowing from the scrubbed hydrocarbon stream outlet via line 386 of the separation unit 370 contains a final concentration of the contaminant of at least 10 times, about 40 times, or about 100 times less than the initial concentration of the contaminant.

In one or more embodiments, the solvent stream is an aqueous stream and is diverted or otherwise flowed from the separation unit 370 to a mixer (not shown). The solvent stream or aqueous stream is concentrated and/or dried and then blended with a product in the mixer. The product may be or contain one or more of a processed grain, vegetable meal, fruit meal, protein meal, meat, stover, hay, forage, or any combination thereof. The mixer may be or contain one or more of a tumbler mixer, paddle mixer, cone mixer, screw mixer, or any combination thereof.

A finishing unit 388 may be fluidly coupled to and downstream of the scrubbed hydrocarbon stream outlet via line 386 of the separation unit 370. The finishing unit 388 may be or contain a centrifuge, a cross-flow filtration unit, a coalescer, a decanter, an electrostatic separator, a membrane purifier, or any combination thereof. The scrubbed hydrocarbon stream outlet via line 386 may be flowed to and introduce into a finishing unit 388 that contains a purified hydrocarbon stream outlet or line 390 for providing a purified hydrocarbon stream 392. The finishing unit 388 also contains a water-solvent waste outlet or line 394 for providing a water-solvent waste stream 396. The purified hydrocarbon stream 392 has a final concentration of the contaminant of at least 10 times, about 20 times, about 100 times less than the initial concentration of the contaminant.

A finishing unit 302 may be fluidly coupled to and downstream of the solvent stream outlet via line 398 of the separation unit 370. The finishing unit 302 may be or contain a centrifuge, a cross-flow filtration unit, a coalescer, a decanter, an electrostatic separator, a membrane purifier, or any combination thereof. The finishing unit 302 contains a water-solvent waste stream via line 306 and a hydrocarbon stream via line 302. The water-solvent waste stream via line 306 may be further processed in a water-solvent purification system 303 via line 301 and a pump 308. Alternatively, the water-solvent waste stream via line 306 may be recycled via line 305 and/or line 307 and a pump 308 into any component of the system downstream of the deaerator unit 314. The water-solvent purification system 303 may be used to transport and introduce one or more solvents, including water and/or steam, into any component in the system which uses solvent, solvent vapor, water, and/or steam. The hydrocarbon stream via line 304 may be recycled back into the hydrocarbon purification system 300, such as being transferred to the feedstock hydrocarbon source 310, the deaerator 314, or components of the hydrocarbon purification system 300.

In one or more embodiments, the streams throughout the hydrocarbon purification system 300 have different amounts of solvent (e.g., water) within the various portions of the hydrocarbon purification system 300. In one or more examples, each of the streams at line 305 and/or line 307 may independently contain a concentration of water or other solvent in a range from about 0 wt % to about 50 wt %, about 2 wt % to about 30 wt %, or about 5 wt % to about 20 wt % relative to the mass percentage of hydrocarbon within and contained at the respective line. In other examples, each of the streams at line 346 and/or line 348 and/or line 356 may independently contain a concentration of water or other solvent in a range from about 0 wt % to about 20 wt %, about 2 wt % to about 15 wt %, or about 5 wt % to about 10 wt % relative to the mass percentage of hydrocarbon within and contained at the respective line. In some examples, the stream at line 380 may contain a concentration of water or other solvent in a range from about 5 wt % to about 50 wt %, about 5 wt % to about 35 wt %, or about 5 wt % to about 20 wt % relative to the mass percentage of hydrocarbon within and contained at line 380.

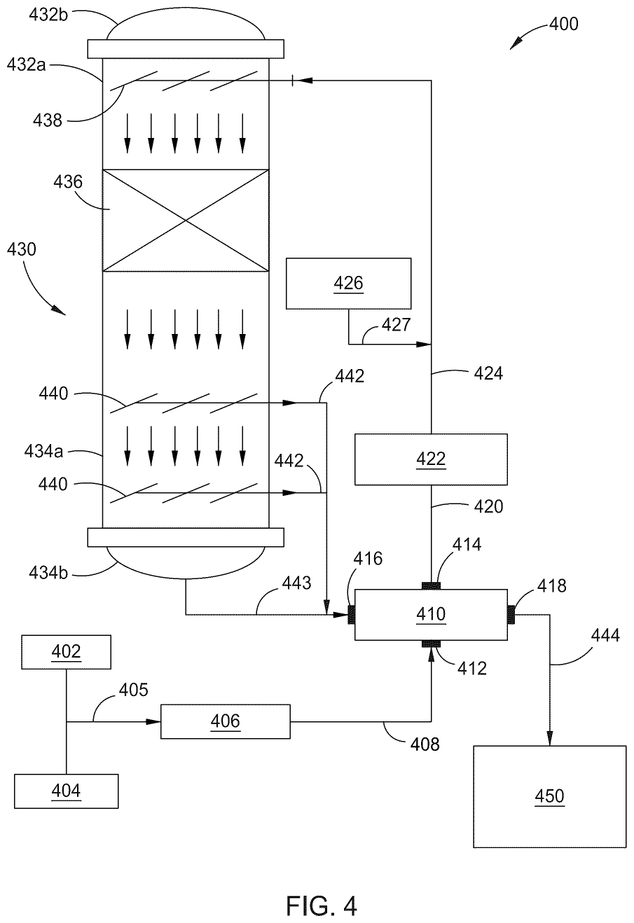

FIG. 4 depicts a flow reactor system 400 containing a liquid-filled laminar flow reactor 430, according to one or more embodiments described and discussed herein. The flow reactor system 400 and the liquid-filled laminar flow reactor 430 are configured to purify a feedstock hydrocarbon. Each of the flow reactor system 400 and the liquid-filled laminar flow reactor 430 may independently be incorporated into the hydrocarbon purification systems 200, 300. In one or more embodiments, the liquid-filled laminar flow reactor 430 is used as the laminar flow reactor 230 in the hydrocarbon purification system 200. In other embodiments, the liquid-filled laminar flow reactor 430 is used as the laminar flow reactor 350 in the hydrocarbon purification system 300.

In one or more embodiments, the hydrocarbon purification system 400 for purifying a hydrocarbon is provided and contains a feedstock hydrocarbon source 406. The feedstock hydrocarbon source 406 contains a feedstock hydrocarbon containing one or more of an oil, a fat, a grease, or any combination thereof, as well as other type of feedstock hydrocarbon discussed further below. The feedstock hydrocarbon has an initial concentration of a contaminant which is reduced and/or removed by the method 100 and/or with the processes and methods described and discussed herein.

In one or more embodiments, the feedstock hydrocarbon may be or contain a non-polar fluid, e.g., petroleum-based feedstocks, such as petroleum crude oil, shale oil, petroleum refinery intermediate streams (such as vacuum tower bottoms (VTB)), pyrolysis oils, recycled plastics, coal liquids, used motor oil, and mixtures thereof. Alternatively, the feedstock hydrocarbon may be or contain a renewable feedstock, such as plant oil. Suitable plant oils include oils of camelina, canola, Carinata, castor, coconut, Jatropha, palm, peanut, Pongamia, soy bean, tung, and/or corn (such as derived from distiller grains), soap stock, waste vegetable oil, yellow grease (from cooking oil), brown grease (from grease traps and wastewater treatment), highly acidic oils (also referred to as acidic oils), animal tallow, algal oil, microbial oil, terpenes and other pine-related byproducts from tall oils, pine oils, or other biosynthetic oils and/or pyrolysis oils (such as derived from pyrolysis, esterification, oligomerization, or polymerization) and mixtures thereof. In some embodiments, the feedstock hydrocarbon may be plant based, animal based, insect based, microbial based, or any combination thereof. In one or more embodiments, the feedstock hydrocarbon may be or contain a food oil which may include one or more plant oils, one or more plant based oils, one or more animal based oils, or any combination thereof. In some embodiments, the feedstock hydrocarbon may be or contain one food oils, purified and/or non-purified food oils, other oils, greases, fats, and/or other substances (e.g., vegetable oils, animal fats, fatty acids, fatty alcohols, and mineral oils), according to one or more embodiments described and discussed herein. In one or more embodiments, the feedstock hydrocarbon may be or contain soybean oil, coconut oil, palm oil, canola oil, corn oil, peanut oil, sunflower oil, cottonseed oil, olive oil, beef fat or lard, pork fat or lard, poultry fat, fish oil, tall oil, pyrolysis oil, or any combination thereof. In one or more examples, the feedstock hydrocarbon may be or contain soybean oil, corn oil, canola oil, camelina oil, yellow grease, choice white grease, beef tallow, poultry fat, used cooking oil, pyrolysis oil, or any combination thereof. In other examples, the feedstock hydrocarbon may be or contain one or more polymeric materials, one or more plastic materials, one or more oligomers, or any combination thereof. Exemplary polymeric materials and/or plastic materials may be or contain one or more of polyethylene terephthalate (PETE), high density polyethylene (HDPE), polyvinyl chloride (PVC), low density polyethylene (LDPE), polypropylene (PP), polystyrene (PS), derivatives thereof, or any combination thereof.

The feedstock hydrocarbon may contain one or more contaminants which are reduced and/or removed by the methods described and discussed herein. Exemplary contaminants contained in the feedstock hydrocarbon may be or contain one or more of a halide (e.g., Cl, F, Br, I), phosphorous, sulfur, nitrogen, a gum or lecithin, a transition metal, an alkali metal, a rare earth metal, other metals, a metalloid, a heavy metal, an inorganic, or any combination thereof. In some examples, the contaminant of total metals may be or contain sodium, potassium, magnesium, calcium, iron, or any combination thereof.

A solvent source 402 and an additive source 404 via one or more lines 405 are fluidly coupled to and upstream of the feedstock hydrocarbon source 406. One or more solvents including water may be transferred from the solvent source 402 and one or more additives may be transferred from the additive source 404 via line 405 and introduced and combined into the feedstock hydrocarbon within the feedstock hydrocarbon source 406.

The solvent in the solvent source 402 may contain one or more of a polar protic solvent, a polar aprotic solvent, a nonpolar hydrocarbon solvent, a nonpolar ether solvent, a nonpolar chlorocarbon solvent, or any combination thereof. For example, the solvent may be or include one or more alcohols, one or more ketones, one or more aromatics, one or more alky sulfoxides, one or more furans, or any combination thereof. Exemplary solvents may be water, methanol, ethanol, propanol, butanol, glycerol, acetone, methyl ethyl ketone, benzene, toluene, xylene, dimethyl sulfoxide (DMSO), tetrahydrofuran, supercritical carbon dioxide, or any combination thereof. The additive source 404 contains one or more additives may be or contain one or more hydrolyzing agents, one or more acids, one or more bases, one or more salts, one or more chelating agents, one or more polar solvents, one or more non-polar solvents, or any combination thereof.

The additive source 404 may contain one or more additives. Exemplary additives may be or contain one or more of a hydrolyzing agent, an acid, a base, a salt, a chelating agent, a polar solvent, a non-polar solvent, or any combination thereof. In one or more examples, the additive may be or contain one or more hydrolyzing agents. The hydrolyzing agent may be or contain any chemical capable of hydrolyzing a hydrocarbon, e.g., fat, oil, or grease. For example, the hydrolyzing agent may be or contain acetic acid, ascorbic acid, citric acid, hydrochloric acid, fumaric acid, glucaric acid, gluconic acid, glutamic acid, hydrochloric acid, lactic acid, malic acid, oxalic acid, phosphoric acid, propionic acid, sulfuric acid, tartaric acid, salts thereof, or any combination thereof. As a further example, the hydrolyzing agent may be or contain nitrilotriacetic acid (NTA), ethylenediaminetetraacetic acid (EDTA), sodium hydroxide, potassium hydroxide, lithium hydroxide, ammonium hydroxide, or any combination thereof. Without being bound by theory the additive may react with a triglyceride to separate a fatty acid of the triglyceride from the glycerin backbone, allowing for the purification of the fatty acids in the triglyceride. Additionally, and without being bound by theory, the additive may hydrolyze phospholipids and other contaminants more readily than fatty acids, allowing for selective hydrolyzing of phospholipids at lower temperatures and with shorter residence times than those required for fatty acid splitting of triglycerides, reducing free fatty acid formation in the hydrocarbon purification system 400 including the liquid-filled laminar flow reactor 430. Additionally, and without being bound by theory, the additive may increase a density and/or molecular weight of the aqueous phase, thereby promoting faster separation of the organic phase and the aqueous phase. In one or more embodiments, the feedstock hydrocarbon via line 405 may include about 50 parts per million (ppm) to about 20,000 ppm of one or more additives, e.g., about 50 ppm to about 1,000 ppm, about 1,000 ppm to about 4,000 ppm, about 4,000 ppm to about 6,000 ppm, about 6,000 ppm to about 8,000 ppm, about 8,000 ppm to about 10,000 ppm, or about 10,000 ppm to about 20,000 ppm.

The feedstock hydrocarbon containing the additive is transferred via line 408 to one or more heating units fluidly coupled to and downstream of the feedstock hydrocarbon source 406. The heating units may include one or more primary heating units and one or more supplemental heating units fluidly coupled to and downstream of the hydrocarbon source 406 and/or fluidly coupled to and upstream of a liquid-filled laminar flow reactor 430. A heating unit may be or contain a heating portion of a recuperator 410 which extends between inlet 412 and outlet 414. The feedstock hydrocarbon containing the additive is transferred via line 408, into inlet 412 and out of the outlet 414, while flowing through and being heated in the heating portion of the recuperator 410. The heated feedstock hydrocarbon may flow via line 420 through a secondary heater, such as a heater 422. Each of the heating portion of a recuperator 410 and/or the heater 422 may be substituted with other types of heating units including an electric heater, a fuel combustion heater, a steam heater, other heating sources, or any combination thereof.

The heated feedstock hydrocarbon may be flowed via line 424 to the liquid-filled laminar flow reactor 430 containing an upper portion 432b opposite a lower portion 434b. A primary solvent source 426 via line 427 may be fluidly coupled to line 424 and configured to introduce one or more solvents (e.g., water, steam, organic solvent, organic vapor) into the heated feedstock hydrocarbon in line 424 to produce a hydrocarbon-solvent stream prior to introducing the hydrocarbon-solvent stream into the liquid-filled laminar flow reactor 430. As such, the feedstock hydrocarbon and/or the hydrocarbon-solvent stream may be introduced into an upper reactor segment 432a by line 424.

In one or more embodiments, the primary solvent (e.g., steam or vaporized solvent) from the primary solvent source 426 may be introduced prior to the liquid-filled laminar flow reactor 430 into line 424 through one or more injection devices disposed at line 427. For example, line 427 may be or contain one or more injection devices in fluid communication with the liquid-filled laminar flow reactor 430. The injection device may be or contain one or more distributors, valves, nozzles, other injecting devices, or any combination thereof. The primary solvent may have a pressure drop across the injection device at line 427 in a range from about 0.0001 psi, about 0.005 psi, about 0.001 psi, about 0.05 psi, about 0.01 psi, about 0.5 psi, or about 0.1 psi to about 1 psi, about 5 psi, about 10 psi, about 20 psi, about 30 psi, about 40 psi, about 50 psi, about 60 psi, about 70 psi, about 80 psi, or greater. For example, the primary solvent may independently have a pressure drop across the injection device at line 427 in a range from about 0.0001 psi to about 80 psi, about 0.0001 psi to about 60 psi, about 0.0001 psi to about 40 psi, about 0.0001 psi to about 20 psi, about 0.0001 psi to about 10 psi, about 0.0001 psi to about 5 psi, about 0.0001 psi to about 1 psi, about 0.0001 psi to about 0.1 psi, about 0.0001 psi to about 0.01 psi, about 0.0001 psi to about 0.001 psi, about 0.0001 psi to about 0.0005 psi, about 0.001 psi to about 80 psi, about 0.001 psi to about 60 psi, about 0.001 psi to about 40 psi, about 0.001 psi to about 20 psi, about 0.001 psi to about 10 psi, about 0.001 psi to about 5 psi, about 0.001 psi to about 1 psi, about 0.001 psi to about 0.1 psi, about 0.001 psi to about 0.01 psi, about 0.01 psi to about 80 psi, about 0.01 psi to about 60 psi, about 0.01 psi to about 40 psi, about 0.01 psi to about 20 psi, about 0.01 psi to about 10 psi, about 0.01 psi to about 5 psi, about 0.01 psi to about 1 psi, or about 0.01 psi to about 0.1 psi.

The solvent in the solvent source 426 may contain one or more of a polar protic solvent, a polar aprotic solvent, a nonpolar hydrocarbon solvent, a nonpolar ether solvent, a nonpolar chlorocarbon solvent, or any combination thereof. For example, the solvent may be or include one or more alcohols, one or more ketones, one or more aromatics, one or more alky sulfoxides, one or more furans, or any combination thereof. Exemplary solvents may be water, methanol, ethanol, propanol, butanol, glycerol, acetone, methyl ethyl ketone, benzene, toluene, xylene, dimethyl sulfoxide (DMSO), tetrahydrofuran, supercritical carbon dioxide, or any combination thereof.

In one or more embodiments, the liquid-filled laminar flow reactor 430 contains one or more inflow distributor assemblies 438 in the upper reactor segment 432a, one or more outflow header assemblies 440 in a lower reactor segment 434a, one or more packing assemblies 436, or any combination thereof. In some examples, the liquid-filled laminar flow reactor 430 contains one or more packing assemblies 436 disposed between the inflow distributor assembly 438 and the outflow header assembly 440. In one or more embodiments, the liquid-filled laminar flow reactor 430 contains one inflow distributor assembly 438 in the upper reactor segment 432a, two outflow header assemblies 440 in the lower reactor segment 434a, and one packing assembly 436 between the inflow distributor assembly 438 and the outflow header assemblies 440. In other embodiments, the liquid-filled laminar flow reactor 430 contains one inflow distributor assembly 438 in the upper reactor segment 432a and one or two outflow header assemblies 440 in the lower reactor segment 434a, but lacking the packing assembly 436.

The inflow distributor assembly 438 is fluidly coupled to line 424 and configured to receive the hydrocarbon-solvent stream. The inflow distributor assembly 438 sprays or otherwise distributes the hydrocarbon-solvent stream across the diameter of the liquid-filled laminar flow reactor 430. The outflow header assemblies 440 may be distributed in the lower reactor segment 434a so that residence time of the hydrocarbon-solvent stream may be varied as desired through the liquid-filled laminar flow reactor 430.

The packing assembly 436 may be used to restrict one or more flows of the hydrocarbon-solvent stream. The packing assembly 436 may be or contain one or more packing materials, such as a random packing material, a structured packing material, one or more sieve trays, or a combination thereof. For example, the packing assembly 436 may be or contain a polymeric material, a ceramic material, a metallic material, a glass material, or any combination thereof. In one or more examples, the packing assembly 436 contains one or more packing materials disposed within the liquid-filled laminar flow reactor 430. While only one packing assembly 436 is depicted in FIG. 4, any number of the packing assemblies 436 may be placed in the liquid-filled laminar flow reactor 430. For example, there may be 1, 2, 3, 4, 5 or more packing assemblies 436 disposed in the packing assemblies 436. Without being bound by theory the packing assembly 436 may be disposed in the liquid-filled laminar flow reactor 430 on one or more of a void fraction, surface area, unit volume, random packing arrangement, structure packing arrangement, tray, continuous phase, dispersed phase, viscosity, and/or surface tension.

The hydrocarbon-solvent stream exits the liquid-filled laminar flow reactor 430 via lines 442. The hydrocarbon-solvent stream may flow through the outflow header assemblies 440 and then lines 442 which are fluidly coupled to and downstream of the outflow header assemblies 440. The hydrocarbon-solvent stream may flow through the 434b and then line 443 to exit the liquid-filled laminar flow reactor 430. The hydrocarbon-solvent streams via line 442 may merge and combine with the hydrocarbon-solvent streams via line 443.

The hydrocarbon-solvent stream via line 443 may be flowed from the liquid-filled laminar flow reactor 430 and through one or more cooling units. The cooling unit is fluidly coupled to and downstream of the lower portion 434b of the liquid-filled laminar flow reactor 430. The hydrocarbon-solvent stream via line 443 may be flowed into a cooling portion of the recuperator 410 which extends between inlet 416 and outlet 418. The hydrocarbon-solvent stream is transferred via line 443, into inlet 416 and out of the outlet 418, while flowing through and being cooled in the cooling portion of the recuperator 410. The cooling unit may be substituted with other types of cooling units including air cooled and/or a circulation cooling systems.

The cooled hydrocarbon-solvent stream may be flowed via line 444 into and through one or more other units and/or systems 450. The units and/or systems 450 may be or include any one or more components in the systems 200, 300. The units and/or systems 450 may be any of the portions of systems 200, 300 downstream from the laminar flow reactor 230 and/or the laminar flow reactor 350, respectively. In one or more embodiments, the cooled hydrocarbon-solvent stream via line 444 may enter the hydrocarbon purification system 200 at the pressure reduction device 240, the separation unit 245, and/or any other segment or portion of the hydrocarbon purification system 200. In other embodiments, the cooled hydrocarbon-solvent stream via line 444 may enter the hydrocarbon purification system 300 at the pressure reduction device 364, the separation unit 370, and/or any other segment or portion of the hydrocarbon purification system 300.

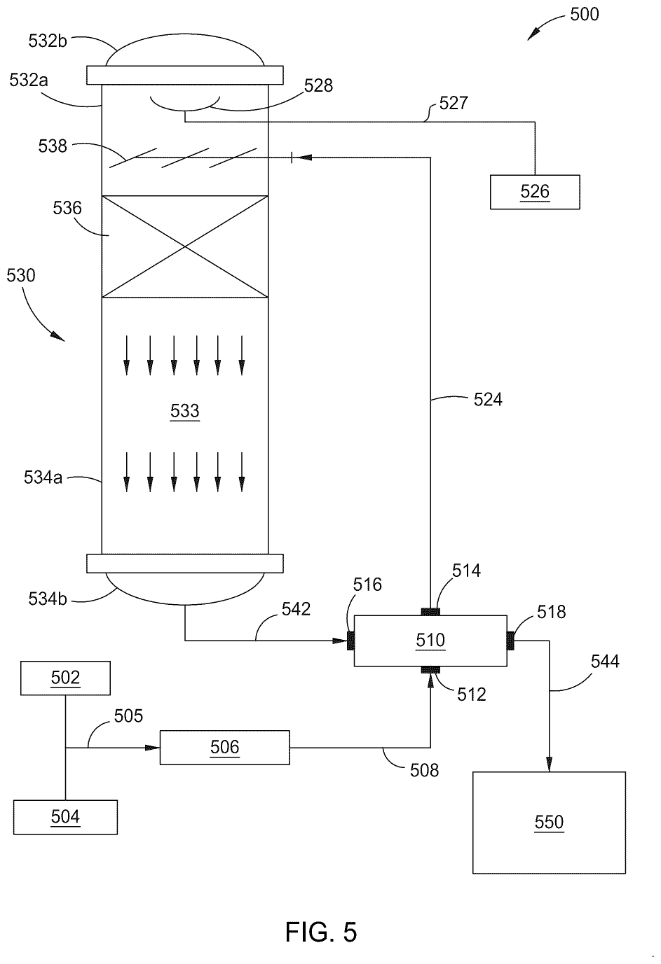

FIG. 5 depicts a flow reactor system 500 containing a vapor-infused laminar flow reactor 530, according to one or more embodiments described and discussed herein. The flow reactor system 500 and the vapor-infused laminar flow reactor 530 are configured to purify a feedstock hydrocarbon. Each of the flow reactor system 400 and the vapor-infused laminar flow reactor 530 may independently be incorporated into the hydrocarbon purification systems 200, 300. In one or more embodiments, the vapor-infused laminar flow reactor 530 is used as the laminar flow reactor 230 in the hydrocarbon purification system 200. In other embodiments, the vapor-infused laminar flow reactor 530 is used as the laminar flow reactor 350 in the hydrocarbon purification system 300.

In one or more embodiments, the hydrocarbon purification system 500 for purifying a hydrocarbon is provided and contains a feedstock hydrocarbon source 506. The feedstock hydrocarbon source 506 contains a feedstock hydrocarbon containing one or more of an oil, a fat, a grease, or any combination thereof, as well as other type of feedstock hydrocarbon discussed further below. The feedstock hydrocarbon has an initial concentration of a contaminant which is reduced and/or removed by the method 100 and/or with the processes and methods described and discussed herein.

In one or more embodiments, the feedstock hydrocarbon may be or contain a non-polar fluid, e.g., petroleum-based feedstocks, such as petroleum crude oil, shale oil, petroleum refinery intermediate streams (such as vacuum tower bottoms (VTB)), pyrolysis oils, recycled plastics, coal liquids, used motor oil, and mixtures thereof. Alternatively, the feedstock hydrocarbon may be or contain a renewable feedstock, such as plant oil. Suitable plant oils include oils of camelina, canola, Carinata, castor, coconut, Jatropha, palm, peanut, Pongamia, soy bean, tung, and/or corn (such as derived from distiller grains), soap stock, waste vegetable oil, yellow grease (from cooking oil), brown grease (from grease traps and wastewater treatment), highly acidic oils (also referred to as acidic oils), animal tallow, algal oil, microbial oil, terpenes and other pine-related byproducts from tall oils, pine oils, or other biosynthetic oils and/or pyrolysis oils (such as derived from pyrolysis, esterification, oligomerization, or polymerization) and mixtures thereof. In some embodiments, the feedstock hydrocarbon may be plant based, animal based, insect based, microbial based, or any combination thereof. In one or more embodiments, the feedstock hydrocarbon may be or contain a food oil which may include one or more plant oils, one or more plant based oils, one or more animal based oils, or any combination thereof. In some embodiments, the feedstock hydrocarbon may be or contain one food oils, purified and/or non-purified food oils, other oils, greases, fats, and/or other substances (e.g., vegetable oils, animal fats, fatty acids, fatty alcohols, and mineral oils), according to one or more embodiments described and discussed herein. In one or more embodiments, the feedstock hydrocarbon may be or contain soybean oil, coconut oil, palm oil, canola oil, corn oil, peanut oil, sunflower oil, cottonseed oil, olive oil, beef fat or lard, pork fat or lard, poultry fat, fish oil, tall oil, pyrolysis oil, or any combination thereof. In one or more examples, the feedstock hydrocarbon may be or contain soybean oil, corn oil, canola oil, camelina oil, yellow grease, choice white grease, beef tallow, poultry fat, used cooking oil, pyrolysis oil, or any combination thereof. In other examples, the feedstock hydrocarbon may be or contain one or more polymeric materials, one or more plastic materials, one or more oligomers, or any combination thereof. Exemplary polymeric materials and/or plastic materials may be or contain one or more of polyethylene terephthalate (PETE), high density polyethylene (HDPE), polyvinyl chloride (PVC), low density polyethylene (LDPE), polypropylene (PP), polystyrene (PS), derivatives thereof, or any combination thereof.

The feedstock hydrocarbon may contain one or more contaminants which are reduced and/or removed by the methods described and discussed herein. Exemplary contaminants contained in the feedstock hydrocarbon may be or contain one or more of a halide (e.g., Cl, F, Br, I), phosphorous, sulfur, nitrogen, a gum or lecithin, a transition metal, an alkali metal, a rare earth metal, other metals, a metalloid, a heavy metal, an inorganic, or any combination thereof. In some examples, the contaminant of total metals may be or contain sodium, potassium, magnesium, calcium, iron, or any combination thereof.

A solvent source 502 and an additive source 504 via one or more lines 505 are fluidly coupled to and upstream of the feedstock hydrocarbon source 506. One or more solvents including water may be transferred from the solvent source 502 and one or more additives may be transferred from the additive source 504 via line 505 and introduced and combined into the feedstock hydrocarbon within the feedstock hydrocarbon source 506.

The solvent in the solvent source 502 may contain one or more of a polar protic solvent, a polar aprotic solvent, a nonpolar hydrocarbon solvent, a nonpolar ether solvent, a nonpolar chlorocarbon solvent, or any combination thereof. For example, the solvent may be or include one or more alcohols, one or more ketones, one or more aromatics, one or more alky sulfoxides, one or more furans, or any combination thereof. Exemplary solvents may be water, methanol, ethanol, propanol, butanol, glycerol, acetone, methyl ethyl ketone, benzene, toluene, xylene, dimethyl sulfoxide (DMSO), tetrahydrofuran, supercritical carbon dioxide, or any combination thereof. The additive source 504 contains one or more additives may be or contain one or more hydrolyzing agents, one or more acids, one or more bases, one or more salts, one or more chelating agents, one or more polar solvents, one or more non-polar solvents, or any combination thereof.

The additive source 504 may contain one or more additives. Exemplary additives may be or contain one or more of a hydrolyzing agent, an acid, a base, a salt, a chelating agent, a polar solvent, a non-polar solvent, or any combination thereof. In one or more examples, the additive may be or contain one or more hydrolyzing agents. The hydrolyzing agent may be or contain any chemical capable of hydrolyzing a hydrocarbon, e.g., fat, oil, or grease. For example, the hydrolyzing agent may be or contain acetic acid, ascorbic acid, citric acid, hydrochloric acid, fumaric acid, glucaric acid, gluconic acid, glutamic acid, hydrochloric acid, lactic acid, malic acid, oxalic acid, phosphoric acid, propionic acid, sulfuric acid, tartaric acid, salts thereof, or any combination thereof. As a further example, the hydrolyzing agent may be or contain nitrilotriacetic acid (NTA), ethylenediaminetetraacetic acid (EDTA), sodium hydroxide, potassium hydroxide, lithium hydroxide, ammonium hydroxide, or any combination thereof. Without being bound by theory the additive may react with a triglyceride to separate a fatty acid of the triglyceride from the glycerin backbone, allowing for the purification of the fatty acids in the triglyceride. Additionally, and without being bound by theory, the additive may hydrolyze phospholipids and other contaminants more readily than fatty acids, allowing for selective hydrolyzing of phospholipids at lower temperatures and with shorter residence times than those required for fatty acid splitting of triglycerides, reducing free fatty acid formation in the hydrocarbon purification system 500 including the vapor-infused laminar flow reactor 530. Additionally, and without being bound by theory, the additive may increase a density and/or molecular weight of the aqueous phase, thereby promoting faster separation of the organic phase and the aqueous phase. In one or more embodiments, the feedstock hydrocarbon via line 505 may include about 50 parts per million (ppm) to about 20,000 ppm of one or more additives, e.g., about 50 ppm to about 1,000 ppm, about 1,000 ppm to about 4,000 ppm, about 4,000 ppm to about 6,000 ppm, about 6,000 ppm to about 8,000 ppm, about 8,000 ppm to about 10,000 ppm, or about 10,000 ppm to about 20,000 ppm.

The feedstock hydrocarbon containing the additive is transferred via line 508 to one or more heating units fluidly coupled to and downstream of the feedstock hydrocarbon source 506. The heating units may include one or more primary heating units and one or more supplemental heating units fluidly coupled to and downstream of the hydrocarbon source 506 and/or fluidly coupled to and upstream of a vapor-infused laminar flow reactor 530. A heating unit may be or contain a heating portion of a recuperator 510 which extends between inlet 512 and outlet 514. The feedstock hydrocarbon containing the additive is transferred via line 508, into inlet 512 and out of the outlet 514, while flowing through and being heated in the heating portion of the recuperator 510. The heated feedstock hydrocarbon may flow via line 524 through a secondary heater, not shown. Each of the heating portion of a recuperator 510 and/or the secondary heater may be substituted with other types of heating units including an electric heater, a fuel combustion heater, a steam heater, other heating sources, or any combination thereof.

The heated feedstock hydrocarbon may be flowed via line 524 to the vapor-infused laminar flow reactor 530 containing an upper portion 532b opposite a lower portion 534b. In one or more embodiments, the vapor-infused laminar flow reactor 530 contains one or more solvent distributors 528 in an upper reactor segment 532a, one or more inflow distributor assemblies 538 in the upper reactor segment 532a, one or more packing assemblies 536, or any combination thereof. In some examples, the vapor-infused laminar flow reactor 530 contains one solvent distributor 528 disposed above one inflow distributor assembly 538, and one or more packing assemblies 536 disposed below the solvent distributor 528 and the inflow distributor assembly 538. A reaction zone 533 is disposed in a lower reactor segment 534a below the packing assembly 536.

A primary solvent source 526 via line 527 may be fluidly coupled to the one or more solvent distributors 528 disposed inside the upper reactor segment 532a of the vapor-infused laminar flow reactor 530. The solvent distributor 528 is configured to introduce one or more solvents (e.g., water, steam, organic solvent, organic vapor) into the upper reactor segment 532a. The heated feedstock hydrocarbon via line 424 may be fluidly coupled to the one or more inflow distributor assemblies 538 in the upper reactor segment 532a. The solvent and the heated feedstock hydrocarbon are combined to produce a hydrocarbon-solvent stream in the vapor-infused laminar flow reactor 530. The solvent in the solvent source 526 may contain one or more of a polar protic solvent, a polar aprotic solvent, a nonpolar hydrocarbon solvent, a nonpolar ether solvent, a nonpolar chlorocarbon solvent, or any combination thereof. For example, the solvent may be or include one or more alcohols, one or more ketones, one or more aromatics, one or more alky sulfoxides, one or more furans, or any combination thereof. Exemplary solvents may be water, methanol, ethanol, propanol, butanol, glycerol, acetone, methyl ethyl ketone, benzene, toluene, xylene, dimethyl sulfoxide (DMSO), tetrahydrofuran, supercritical carbon dioxide, or any combination thereof.

In one or more embodiments, the solvent distributor 528 is fluidly coupled to line 527 and configured to receive the one or more primary solvents (e.g., water, steam, organic solvent, organic vapor). The solvent distributor 528 sprays or otherwise distributes the solvent across the diameter of the vapor-infused laminar flow reactor 530. The inflow distributor assembly 538 is fluidly coupled to line 524 and configured to receive the heated feedstock hydrocarbon. The inflow distributor assembly 538 sprays or otherwise distributes the heated feedstock hydrocarbon across the diameter of the vapor-infused laminar flow reactor 530. The solvent and the heated feedstock hydrocarbon are combined and mixed to produce a hydrocarbon-solvent stream.

The packing assembly 536 may be used to restrict one or more flows of the hydrocarbon-solvent stream. The packing assembly 536 may be or contain one or more packing materials, such as a random packing material, structured packing material, one or more sieve trays, or a combination thereof. For example, the packing assembly 536 may be or contain a polymeric material, a ceramic material, a metallic material, a glass material, or any combination thereof. In one or more examples, the packing assembly 536 contains one or more packing materials disposed within the vapor-infused laminar flow reactor 530. While only one packing assembly 536 is depicted in FIG. 5, any number of the packing assemblies 536 may be placed in the vapor-infused laminar flow reactor 530. For example, there may be 1, 2, 3, 4, 5 or more packing assemblies 536 disposed in the packing assemblies 536. Without being bound by theory the packing assembly 536 may be disposed in the vapor-infused laminar flow reactor 530 on one or more of a void fraction, surface area, unit volume, random packing arrangement, structure packing arrangement, tray, continuous phase, dispersed phase, viscosity, and/or surface tension.

In one or more embodiments, the hydrocarbon-solvent stream may be introduce a flow of the heated hydrocarbon stream into a headspace in an upper portion of the laminar flow reactor. The flow of the heated hydrocarbon stream via line 524 is completely or substantially free of turbulence, and the heated hydrocarbon stream is at a first temperature within the headspace or the upper reactor segment 532a. The hydrocarbon-solvent stream may further be produced by introducing a flow of the primary solvent via line 527 into the headspace or the upper reactor segment 532a, the flow of the primary solvent via line 524 is completely or substantially free of turbulence, and the primary solvent is at a second temperature greater than the first temperature. The hydrocarbon-solvent stream may be produced by condensing the primary solvent into the heated hydrocarbon stream to produce an intermediate stream, and flowing the intermediate stream through the reaction zone 533 disposed in the lower reactor segment 534a to produce the hydrocarbon-solvent stream. The hydrocarbon-solvent stream exits the vapor-infused laminar flow reactor 530 via line 542. The hydrocarbon-solvent stream may flow through line 542 which is fluidly coupled to and downstream of the reaction zone 533.

In one or more embodiments, the primary solvent may be introduced into the headspace through an injection device. The injection device may be or contain one or more distributors, valves, nozzles, other injecting devices, or any combination thereof. The primary solvent may have a pressure drop across the injection device in a range from about 0.0001 psi, about 0.005 psi, about 0.001 psi, about 0.05 psi, about 0.01 psi, about 0.5 psi, or about 0.1 psi to about 1 psi, about 5 psi, about 10 psi, about 20 psi, about 30 psi, about 40 psi, about 50 psi, about 60 psi, about 70 psi, about 80 psi, or greater. For example, the primary solvent may have a pressure drop across the injection device in a range from about 0.0001 psi to about 80 psi, about 0.0001 psi to about 60 psi, about 0.0001 psi to about 40 psi, about 0.0001 psi to about 20 psi, about 0.0001 psi to about 10 psi, about 0.0001 psi to about 5 psi, about 0.0001 psi to about 1 psi, about 0.0001 psi to about 0.1 psi, about 0.0001 psi to about 0.01 psi, about 0.0001 psi to about 0.001 psi, about 0.0001 psi to about 0.0005 psi, about 0.001 psi to about 80 psi, about 0.001 psi to about 60 psi, about 0.001 psi to about 40 psi, about 0.001 psi to about 20 psi, about 0.001 psi to about 10 psi, about 0.001 psi to about 5 psi, about 0.001 psi to about 1 psi, about 0.001 psi to about 0.1 psi, about 0.001 psi to about 0.01 psi, about 0.01 psi to about 80 psi, about 0.01 psi to about 60 psi, about 0.01 psi to about 40 psi, about 0.01 psi to about 20 psi, about 0.01 psi to about 10 psi, about 0.01 psi to about 5 psi, about 0.01 psi to about 1 psi, or about 0.01 psi to about 0.1 psi.

In some embodiments, the vapor-infused laminar flow reactor 530 may be maintained at a pressure in a range from about 1 psi to about 50 psi of a saturation pressure of the primary solvent at a target reaction temperature. In some examples a reaction temperature in the laminar flow reactor is in a range from about 50° C. to about 400° C., and a temperature in the vapor-infused laminar flow reactor 530 may be in a range from about 150° C. to about 300° C., such as about 200° C. to about 275° C.

In one or more examples, the primary solvent comprises, contains, consists of, or consist essential of water and/or steam. In some examples, the primary solvent may be introduced as a superheated vapor, a saturated vapor, or a subcooled vapor.

In one or more embodiments, each of a liquid phase within the headspace of the vapor-infused laminar flow reactor 530 and/or an intermediate stream within the vapor-infused laminar flow reactor 530 and/or a hydrocarbon-solvent stream within the vapor-infused laminar flow reactor 530 may independently persist in laminar flow and have a Reynolds number of 2,300 or less. In one or more embodiments, each of a liquid phase within the headspace of the vapor-infused laminar flow reactor 530 and/or an intermediate stream within the vapor-infused laminar flow reactor 530 and/or a hydrocarbon-solvent stream within the vapor-infused laminar flow reactor 530 may independently have a Reynolds number of about 0, about 10, about 50, about 100, about 200, about 300, about 500, about 600, about 800, about 1,000, about 1,200, about 1,500, about 1,600, about 1,800, less than or about 2,000, less than or about 2,000, less than or about 2,100, less than or about 2,200, less than or about 2250, less than or about 2,290, or 2,300. For example, each of a liquid phase within the headspace of the vapor-infused laminar flow reactor 530 and/or an intermediate stream within the vapor-infused laminar flow reactor 530 and/or a hydrocarbon-solvent stream within the vapor-infused laminar flow reactor 530 may independently have a Reynolds number in a range from about 0 to 2,300, about 0 to about 2,290, about 0 to about 2,250, about 0 to about 2,200, about 0 to about 2,150, about 0 to about 2,100, about 0 to about 2,050, about 0 to about 2,000, about 0 to less than 2,000, about 0 to about 1,800, about 0 to about 1,600, about 0 to about 1,500, about 0 to about 1,200, about 0 to about 1,000, about 0 to about 800, about 0 to about 600, about 0 to about 500, about 0 to about 200, about 0 to about 100, about 500 to 2,300, about 500 to about 2,290, about 500 to about 2,250, about 500 to about 2,200, about 500 to about 2,150, about 500 to about 2,100, about 500 to about 2,050, about 500 to about 2,000, about 500 to less than 2,000, about 500 to about 1,800, about 500 to about 1,600, about 500 to about 1,500, about 500 to about 1,200, about 500 to about 1,000, about 500 to about 800, about 500 to about 600, about 1,000 to 2,300, about 1,000 to about 2,290, about 1,000 to about 2,250, about 1,000 to about 2,200, about 1,000 to about 2,150, about 1,000 to about 2,100, about 1,000 to about 2,050, about 1,000 to about 2,000, about 1,000 to less than 2,000, about 1,000 to about 1,800, about 1,000 to about 1,600, about 1,000 to about 1,500, or about 1,000 to about 1,200. Not to be bound by theory, it is believed that a liquid with a Reynolds number of greater 2,300 has a turbulent flow instead of a laminar flow.

The hydrocarbon-solvent stream via line 542 may be flowed from the vapor-infused laminar flow reactor 530 and through one or more cooling units. The cooling unit is fluidly coupled to and downstream of the lower portion 534b of the vapor-infused laminar flow reactor 530. The hydrocarbon-solvent stream via line 542 may be flowed into a cooling portion of the recuperator 510 which extends between inlet 516 and outlet 518. The hydrocarbon-solvent stream is transferred via line 542, into inlet 516 and out of the outlet 518, while flowing through and being cooled in the cooling portion of the recuperator 510. The cooling unit may be substituted with other types of cooling units including air cooled and/or a circulation cooling systems.

The cooled hydrocarbon-solvent stream may be flowed via line 544 into and through one or more other units and/or systems 550. The units and/or systems 550 may be or include any one or more components in the systems 200, 300. The units and/or systems 550 may be any of the portions of systems 200, 300 downstream from the laminar flow reactor 230 and/or the laminar flow reactor 350, respectively. In one or more embodiments, the cooled hydrocarbon-solvent stream via line 544 may enter the hydrocarbon purification system 200 at the pressure reduction device 240, the separation unit 245, and/or any other segment or portion of the hydrocarbon purification system 200. In other embodiments, the cooled hydrocarbon-solvent stream via line 544 may enter the hydrocarbon purification system 300 at the pressure reduction device 364, the separation unit 370, and/or any other segment or portion of the hydrocarbon purification system 300.

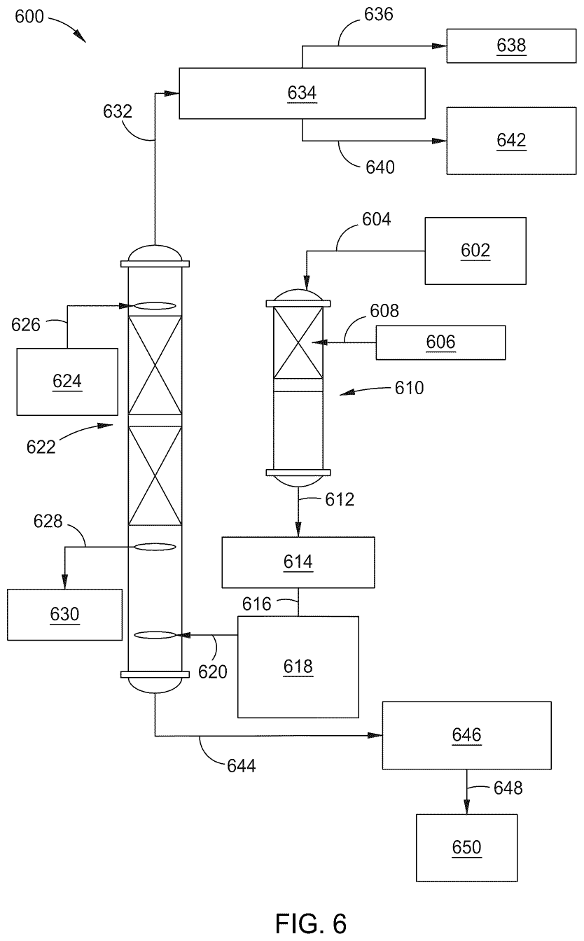

FIG. 6 depicts a system 600 for purifying a feedstock hydrocarbon and recycling process water or other solvents, according to one or more embodiments described and discussed herein. In one or more embodiments, the system 600 is used in conjunction with the hydrocarbon purification systems 200, 300. The system 600 is an efficient system that recycles most, if not all, of the water or other solvents when purifying the feedstock hydrocarbon. The system 600 has an efficiency of greater than 95 wt %, greater than 96 wt %, greater than 97 wt %, such as about 97.5 wt %, about 98 wt %, about 98.5 wt %, about 99 wt % or greater relative to a total solvent concentration within the system 600.

A hydrocarbon source 602 via line 604 may be fluidly coupled to and upstream of a laminar flow reactor 610. The hydrocarbon source 602 contains one or more feedstock hydrocarbon streams. The feedstock hydrocarbon stream may be formed in the hydrocarbon purification systems 200, 300, as described and discussed herein. The feedstock hydrocarbon stream contains one or more feedstock hydrocarbons, one or more additives, and one or more solvents. In one or more examples, the solvent is or contains water and/or steam.

The feedstock hydrocarbon stream via line 604 may contain the solvent in a range from about 1%, about 5%, about 10%, about 15 wt %, about 18 wt %, about 20 wt %, about 22 wt %, or about 24 wt % to about 25 wt %, about 28 wt %, about 30 wt %, about 32 wt %, about 35 wt %, or greater relative to a total solvent concentration within the system 600. For example, the feedstock hydrocarbon stream via line 604 may contain the solvent in a range from about 1% to about 5%, about 1% to about 10%, about 1% to about 15%, about 1% to about 25%, about 15 wt % to about 35 wt %, about 15 wt % to about 30 wt %, about 15 wt % to about 25 wt %, about 15 wt % to about 20 wt %, about 20 wt % to about 35 wt %, about 20 wt % to about 30 wt %, about 20 wt % to about 25 wt %, about 25 wt % to about 30 wt %, about 22 wt % to about 28 wt %, about 23 wt % to about 27 wt %, or about 24 wt % to about 26 wt %, relative to a total solvent concertation within the system 600.

A primary solvent source 606 via line 608 may be fluidly coupled to the laminar flow reactor 610 and configured to introduce one or more solvents (e.g., water, steam, organic solvent, organic vapor) into the feedstock hydrocarbon stream in the laminar flow reactor 610 to produce a hydrocarbon-solvent stream. In some examples, the primary solvent source 606 via line 608 may be fluidly coupled to the laminar flow reactor 610 at or by an upper portion or a middle portion of the laminar flow reactor 610.

In one or more examples, the primary solvent source 606 may be or contain a steam source configured to store and/or disperse water and/or steam. In other examples, the primary solvent source 606 may be or contain a solvent source and be configured to store and/or disperse one or more solvents. The solvent may be or contain one or more of a polar protic solvent, a polar aprotic solvent, a nonpolar hydrocarbon solvent, a nonpolar ether solvent, a nonpolar chlorocarbon solvent, or any combination thereof. For example, the solvent may be or include one or more alcohols, one or more ketones, one or more aromatics, one or more alky sulfoxides, one or more furans, or any combination thereof. Exemplary solvents may be water, methanol, ethanol, propanol, butanol, glycerol, acetone, methyl ethyl ketone, benzene, toluene, xylene, dimethyl sulfoxide (DMSO), tetrahydrofuran, supercritical carbon dioxide, or any combination thereof.

The primary solvent via line 608 may contain the solvent (e.g., water, steam, organic solvent, organic vapor) in a range from about 15 wt %, about 18 wt %, about 20 wt %, about 22 wt %, or about 24 wt % to about 25 wt %, about 28 wt %, about 30 wt %, about 32 wt %, about 35 wt %, or greater relative to a total solvent concentration within the system 600. For example, the primary solvent via line 608 may contain the solvent in a range from about 15 wt % to about 35 wt %, about 15 wt % to about 30 wt %, about 15 wt % to about 25 wt %, about 15 wt % to about 20 wt %, about 20 wt % to about 35 wt %, about 20 wt % to about 30 wt %, about 20 wt % to about 25 wt %, about 25 wt % to about 30 wt %, about 22 wt % to about 28 wt %, about 23 wt % to about 27 wt %, or about 24 wt % to about 26 wt %, relative to a total solvent concentration within the system 600.

The hydrocarbon-solvent stream via line 612 may be flowed from the laminar flow reactor 610 and through one or more cooling units to produce a cooled hydrocarbon-solvent stream via line 616. The cooling unit is fluidly coupled to and downstream of the lower portion of the laminar flow reactor 610. The hydrocarbon-solvent stream via line 612 may be flowed into a cooling portion of the recuperator, a coolant circulation system, a refrigeration system, or other type of cooling units.

The hydrocarbon-solvent stream via lines 612, 616 may contain the solvent (e.g., water, steam, organic solvent, organic vapor) in a range from about 30 wt %, about 35 wt %, about 40 wt %, or about 45 wt % to about 50 wt %, about 55 wt %, about 60 wt %, about 65 wt %, about 70 wt %, or greater relative to a total solvent concentration within the system 600. For example, the hydrocarbon-solvent stream via lines 612, 616 may contain the solvent (e.g., water, steam, organic solvent, organic vapor) in a range from about 30 wt % to about 60 wt %, about 30 wt % to about 55 wt %, about 30 wt % to about 50 wt %, about 30 wt % to about 45 wt %, about 30 wt % to about 40 wt %, about 40 wt % to about 60 wt %, about 40 wt % to about 55 wt %, about 40 wt % to about 50 wt %, about 40 wt % to about 45 wt %, about 45 wt % to about 60 wt %, about 45 wt % to about 55 wt %, about 45 wt % to about 50 wt %, or about 45 wt % to about 48 wt %, relative to a total solvent concentration within the system 600.

The cooled hydrocarbon-solvent stream may be flowed via line 616 into and through one or more pressure reduction devices 618. The pressure reduction device 618 is fluidly coupled to and downstream of the cooling unit 614 via line 616 and fluidly coupled to and upstream of a separation unit 622 via line 620. The pressure reduction device 618 may be or contain a low-shear pressure reduction device, a cyclonic pressure reduction device, a multi-stage pressure reduction device, or any combination thereof. The pressure reduction device 618 may decrease the pressure of the hydrocarbon-solvent stream by about 10 times, about 20 times, about 50 times, about 100 times, or greater between line 362 and line 620. In some examples, the second pressure of the hydrocarbon-solvent stream at line 620 is at least one half of the value of the first pressure of the hydrocarbon-solvent stream at line 616. In one or more examples, the pressure reduction device 618 is a cyclonic pressure reduction device, such as the Typhoon® Valve System, commercially available from the Mokveld Company.

The first pressure of the hydrocarbon-solvent stream at line 616 may be in a range from about 500 psi, greater than 500 psi, about 550 psi, about 600 psi, or about 800 psi to about 1,000 psi, about 1,200 psi, about 1,500 psi, about 1,800 psi, about 2,000 psi, or greater. For example, the first pressure of the hydrocarbon-solvent stream at line 616 may be in a range from about 500 psi to about 2,000 psi, about 500 psi to about 1,800 psi, about 500 psi to about 1,500 psi, about 500 psi to about 1,200 psi, about 500 psi to about 1,000 psi, about 500 psi to about 800 psi, about 500 psi to about 600 psi, about 800 psi to about 2,000 psi, about 800 psi to about 1,800 psi, about 800 psi to about 1,500 psi, about 800 psi to about 1,200 psi, about 800 psi to about 1,000 psi, about 1,000 psi to about 2,000 psi, about 1,000 psi to about 1,800 psi, about 1,000 psi to about 1,500 psi, or about 1,000 psi to about 1,200 psi.

The second pressure of the hydrocarbon-solvent stream at line 620 may be in a range from about 1 psi, about 5 psi, about 10 psi, about 20 psi, about 50 psi, or about 100 psi to about 150 psi, about 200 psi, about 250 psi, about 300 psi, about 350 psi, about 400 psi, about 450 psi, less than 500 psi, about 500 psi. For example, the second pressure of the hydrocarbon-solvent stream at line 620 may be in a range from about 1 psi to less than or about 500 psi, about 1 psi to about 400 psi, about 1 psi to about 350 psi, about 1 psi to about 300 psi, about 1 psi to about 250 psi, about 1 psi to about 200 psi, about 1 psi to about 150 psi, about 1 psi to about 100 psi, about 1 psi to about 80 psi, about 1 psi to about 50 psi, about 1 psi to about 10 psi, about 50 psi to less than or about 500 psi, about 50 psi to about 400 psi, about 50 psi to about 350 psi, about 50 psi to about 300 psi, about 50 psi to about 250 psi, about 50 psi to about 200 psi, about 50 psi to about 150 psi, about 50 psi to about 100 psi, about 50 psi to about 80 psi, about 50 psi to about 60 psi, about 100 psi to less than or about 500 psi, about 100 psi to about 400 psi, about 100 psi to about 350 psi, about 100 psi to about 300 psi, about 100 psi to about 250 psi, about 100 psi to about 200 psi, about 100 psi to about 150 psi, or about 100 psi to about 120 psi.

In one or more examples, the first pressure may be in a range about 500 psi to about 1,500 psi, and the second pressure may be in a range from about 1 psi to about 500 psi. In other examples, the first pressure may be in a range greater than 500 psi to about 1,500 psi, and the second pressure may be in a range from about 1 psi to about 500 psi. In some examples, the first pressure may be in a range about 500 psi to about 1,500 psi, and the second pressure may be in a range from about 1 psi to less than 500 psi.

The separation unit 622 is fluidly coupled to and downstream of the pressure reduction device 618 via line 620. The separation unit 622, as depicted in FIG. 6, is a vertical extraction column. In other embodiments, the separation unit 622 may be a horizontal extraction column, a centrifuge, a cross-flow filtration unit, a coalescer, a decanter, an electrostatic separator, a membrane purifier, or any combination thereof.

One or more solvent or water sources 624 via line 626 may be fluidly coupled to and upstream of the separation unit 622. The solvent or water source 624 may supply and otherwise introduce one or more solvents or water via line 626 into the separation unit 622. The separation unit 622 contains a scrubbed hydrocarbon stream outlet via line 632 and a solvent stream outlet via line 644. In one or more examples, a scrubbed hydrocarbon stream flowing from the scrubbed hydrocarbon stream outlet via line 626 of the separation unit 622 contains a final concentration of the contaminant of at least 10 times, about 40 times, or about 100 times less than the initial concentration of the contaminant. In some examples, a rag discharge unit 630 via line 628 is fluidly coupled to and downstream of a lower portion of the central region of the vertical extraction column 622. The rag discharge unit 630 is configured to receive a rag composition containing a mixture of oil, water, solids, and interfacially active components.

One or more solvent or water sources 624 via line 626 may be fluidly coupled to and upstream of the separation unit 622. The solvent or water source 624 may supply and otherwise introduce one or more solvents or water into the separation unit 622. The separation unit 622 contains a scrubbed hydrocarbon stream outlet via line 632 and a solvent stream outlet via line 644. In one or more examples, a scrubbed hydrocarbon stream flowing from the scrubbed hydrocarbon stream outlet via line 632 of the separation unit 622 contains a final concentration of the contaminant of at least 10 times, about 40 times, or about 100 times less than the initial concentration of the contaminant.

The solvent stream via line 626 may contain the solvent (e.g., water, steam, organic solvent, organic vapor) in a range from about 30 wt %, about 35 wt %, about 40 wt %, or about 45 wt % to about 50 wt %, about 55 wt %, about 60 wt %, about 65 wt %, about 70 wt %, or greater relative to a total solvent concentration within the system 600. For example, the solvent stream via line 626 may contain the solvent (e.g., water, steam, organic solvent, organic vapor) in a range from about 30 wt % to about 60 wt %, about 30 wt % to about 55 wt %, about 30 wt % to about 50 wt %, about 30 wt % to about 45 wt %, about 30 wt % to about 40 wt %, about 40 wt % to about 60 wt %, about 40 wt % to about 55 wt %, about 40 wt % to about 50 wt %, about 40 wt % to about 45 wt %, about 45 wt % to about 60 wt %, about 45 wt % to about 55 wt %, about 45 wt % to about 50 wt %, or about 45 wt % to about 48 wt %, relative to a total solvent concentration within the system 600.

A finishing unit 634 may be fluidly coupled to and downstream of the scrubbed hydrocarbon stream outlet via line 632 of the separation unit 622. The finishing unit 634 may be or contain a centrifuge, a cross-flow filtration unit, a coalescer, a decanter, an electrostatic separator, a membrane purifier, or any combination thereof. The scrubbed hydrocarbon stream outlet via line 632 may be flowed to and introduce into a finishing unit 634 that contains a purified hydrocarbon stream outlet or line 636 for providing a purified hydrocarbon stream 638. The finishing unit 634 also contains a water-solvent waste outlet or line 640 for providing a water-solvent waste stream 642. The purified hydrocarbon stream 638 has a final concentration of the contaminant of at least 10 times, about 20 times, about 100 times less than the initial concentration of the contaminant.

The water-solvent waste stream 642 contains a low amount or portion of water or other solvent relative to total solvent concentration within the system 600. The water-solvent waste stream 642 may contain the solvent (e.g., water, steam, organic solvent, organic vapor) in a range from about 0.1 wt %, about 0.2 wt %, about 0.5 wt %, about 0.8 wt %, or about 1 wt %, about 1.2 wt % to about 1.5 wt %, about 1.8 wt %, about 2 wt %, about 2.2 wt %, about 2.5 wt %, about 2.8 wt %, about 3 wt %, about 3.5 wt %, about 4 wt %, about 5 wt %, or greater relative to a total solvent concentration within the system 600. For example, the water-solvent waste stream 642 may contain the solvent (e.g., water, steam, organic solvent, organic vapor) in a range from about 0.1 wt % to about 5 wt %, about 0.1 wt % to about 4 wt %, about 0.1 wt % to about 3 wt %, about 0.1 wt % to about 2.5 wt %, about 0.1 wt % to about 2.2 wt %, about 0.1 wt % to about 2 wt %, about 0.1 wt % to about 1.8 wt %, about 0.1 wt % to about 1.5 wt %, about 0.1 wt % to about 1.2 wt %, about 0.1 wt % to about 1 wt %, about 0.1 wt % to about 0.8 wt %, about 0.1 wt % to about 0.5 wt %, about 1 wt % to about 5 wt %, about 1 wt % to about 4 wt %, about 1 wt % to about 3 wt %, about 1 wt % to about 2.5 wt %, about 1 wt % to about 2.2 wt %, about 1 wt % to about 2 wt %, about 1 wt % to about 1.8 wt %, about 1 wt % to about 1.5 wt %, about 1 wt % to about 1.2 wt %, about 1.5 wt % to about 5 wt %, about 1.5 wt % to about 4 wt %, about 1.5 wt % to about 3 wt %, about 1.5 wt % to about 2.5 wt %, about 1.5 wt % to about 2.2 wt %, about 1.5 wt % to about 2 wt %, or about 1.5 wt % to about 1.8 wt %, relative to a total solvent concentration within the system 600.

A finishing unit 646 may be fluidly coupled to and downstream of the solvent stream outlet via line 644 of the separation unit 622. The finishing unit 646 may be or contain a centrifuge, a cross-flow filtration unit, a coalescer, a decanter, an electrostatic separator, a membrane purifier, or any combination thereof. The finishing unit 646 contains a water-solvent waste stream via line 648 and a hydrocarbon stream via line (not shown). The water-solvent waste stream via line 648 may be further processed in a water-solvent purification system 650. The water-solvent purification system 650 may be used to transport and introduce one or more solvents, including water and/or steam, into any component in the system which uses solvent, solvent vapor, water, and/or steam. The hydrocarbon stream via line 640 may be recycled back into the system 600, such as being transferred to the feedstock hydrocarbon source 605, the deaerator, or components of the system 600.

The water-solvent waste stream via line 648 contains a large amount or portion of water or other solvent relative to total solvent concentration within the system 600. The water-solvent waste stream via line 648 may contain the solvent (e.g., water, steam, organic solvent, organic vapor) in a range from about 90 wt %, about 92 wt %, about 95 wt %, about 96 wt %, or about 97 wt % to about 97.5 wt %, about 98 wt %, about 98.2 wt %, about 98.5 wt %, about 98.8 wt %, about 99 wt %, about 99.2 wt %, about 99.5 wt %, about 99.8 wt %, about 99.9, or greater relative to a total solvent concentration within the system 600. For example, the water-solvent waste stream via line 648 may contain the solvent (e.g., water, steam, organic solvent, organic vapor) in a range from about 90 wt % to about 99.9 wt %, about 90 wt % to about 99.5 wt %, about 90 wt % to about 99.2 wt %, about 90 wt % to about 99 wt %, about 90 wt % to about 98.8 wt %, about 90 wt % to about 98.5 wt %, about 90 wt % to about 98.2 wt %, about 90 wt % to about 98 wt %, about 90 wt % to about 97.5 wt %, about 90 wt % to about 97 wt %, about 90 wt % to about 96 wt %, about 90 wt % to about 95 wt %, about 90 wt % to about 92 wt %, about 95 wt % to about 99.9 wt %, about 95 wt % to about 99.5 wt %, about 95 wt % to about 99.2 wt %, about 95 wt % to about 99 wt %, about 95 wt % to about 98.8 wt %, about 95 wt % to about 98.5 wt %, about 95 wt % to about 98.2 wt %, about 95 wt % to about 98 wt %, about 95 wt % to about 97.5 wt %, about 95 wt % to about 97 wt %, about 95 wt % to about 96 wt %, about 95 wt % to about 95.5 wt %, about 97 wt % to about 99.9 wt %, about 97 wt % to about 99.5 wt %, about 97 wt % to about 99.2 wt %, about 97 wt % to about 99 wt %, about 97 wt % to about 98.8 wt %, about 97 wt % to about 98.5 wt %, about 97 wt % to about 98.2 wt %, about 97 wt % to about 98 wt %, or about 97 wt % to about 97.5 wt %, relative to a total solvent concentration within the system 600.

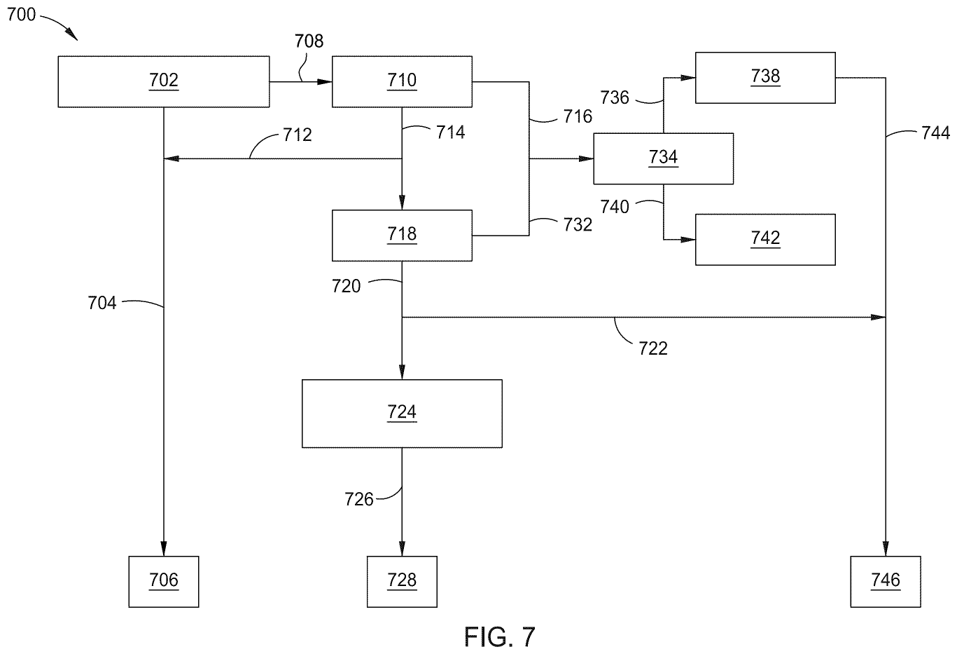

FIG. 7 depicts a solvent recycling system 700 for purifying and recycling process water, according to one or more embodiments described and discussed herein. In one or more embodiments, the solvent recycling system 700 is used in conjunction with the hydrocarbon purification systems 200, 300 and/or the system 600, as described and discussed herein. In one or more examples, the solvent recycling system 700 is used in conjunction with the water-solvent waste stream 275 of the hydrocarbon purification system 200, the water-solvent purification system 303 of the hydrocarbon purification system 300, and the water-solvent waste stream via line 648 and/or the water-solvent purification system 650 of the system 600. The solvent recycling system 700 is an efficient system that recycles most, if not all, of the water or other solvents when purifying the feedstock hydrocarbon.

The solvent recycling system 700 contains a water-solvent waste stream source 702. The water-solvent waste stream source 702 contains the water-solvent waste stream which may be direct from the water-solvent waste stream 275 of the hydrocarbon purification system 200, the water-solvent purification system 303 of the hydrocarbon purification system 300, and the water-solvent waste stream via line 648 and/or the water-solvent purification system 650 of the system 600, as described and discussed herein. In some embodiments, the water-solvent waste stream may be flowed via line 704 from the water-solvent waste stream source 702 to a source 706. The source 706 may store and/or transport the water-solvent waste stream to further reuse in several portions of the hydrocarbon purification systems 200, 300 and/or the system 600, such as in the reactors.

The water-solvent waste stream in source 706 may have a purity of about 95 wt % to 99 wt %. For example, the water-solvent waste stream in source 706 may have a purity of about 95 wt %, about 95.5 wt %, about 96 wt %, about 96.5 wt %, or about 97 wt % to about 97.5 wt %, about 98 wt %, about 98.5 wt %, about 98.8 wt %, or 99 wt %. In some examples, the water-solvent waste stream in source 706 may have a purity in a range from about 95 wt % to 99 wt %, about 96 wt % to 99 wt %, about 97 wt % to 99 wt %, about 97.5 wt % to 99 wt %, about 98 wt % to 99 wt %, about 98.5 wt % to 99 wt %, about 95 wt % to about 98 wt %, about 96 wt % to about 98 wt %, about 97 wt % to about 98 wt %, about 97.5 wt % to about 98 wt %, about 95 wt % to about 97 wt %, or about 96 wt % to about 97 wt %.

In one or more examples, the source 706 may be one or more of the liquid solvent sources introduced upstream of the laminar flow reactor via lines 305 and/or 307.

In other examples, the source 706 may be the recycled water-solvent in line 307 fluidly coupled to the laminar flow reactor 350 and configured to introduce one or more solvents in the hydrocarbon purification system 300.

In one or more examples, the source 706 may be the water-solvent purification system 650 and/or is configured to supply solvent to the hydrocarbon source 602 which is fluidly coupled to the laminar flow reactor 610 via line 604 and configured to introduce one or more solvents in the hydrocarbon purification system 600.

The water-solvent waste stream in the water-solvent waste stream source 702 may be transported via line 708 to a filtration unit 710 to produce a concentrate via line 716 and a permeate via line 714. The filtration unit 710 may be or contain one or more of a cross-filtration unit, a leaf filter, filter press, or any combination thereof. The permeate of the water-solvent waste stream via line 714 may be directed to and combined into with the water-solvent waste stream in line 704 and further transported to the source 706. In other examples, the permeate of the water-solvent waste stream via line 714 may be introduced to and treated in a reverse osmosis unit 718 to produce a concentrate via line 732 and a permeate via line 720.

In some examples, the permeate via line 720 may be transferred to and introduced into a filter unit 724 to produce a purified solvent via line 726. The filter unit may be of contain one or more activated carbon absorption filters, one or more deionized filters, or any combination thereof. The purified solvent via line 726 may be introduced and stored in the source 728 as a purified solvent. The purified solvent in a source 728 may have a purity of greater than 99.99 wt %. For example, the purified solvent in a source 728 may have a purity of greater than 99.99 wt %, about 99.995 wt %, about 99.999 wt %, about 99.9995 wt %, about 99.9999 wt %, about 99.99995 wt %, about 99.9999 wt %, or greater. In one or more examples, the purified solvent in a source 728 may have a purity in a range from greater than 99.99 wt % to about 99.9999 wt %, greater than 99.99 wt % to about 99.9995 wt %, greater than 99.99 wt % to about 99.999 wt %, greater than 99.99 wt % to about 99.995 wt %, about 99.995 wt % to about 99.9999 wt %, about 99.995 wt % to about 99.9995 wt %, about 99.995 wt % to about 99.999 wt %, about 99.999 wt % to about 99.9999 wt %, or about 99.999 wt % to about 99.9995 wt %.

In one or more embodiments, the purified solvent stored in the source 728 is the highest purity solvent within the system 700. The source 728 may store and/or transport the purified solvent to further reuse in any portion or component of the hydrocarbon purification systems 200, 300 and/or the system 600, such as in the extraction columns, the reactors, any of the solvent sources.

In other examples, the permeate via line 720 may be transferred to and introduced into a source 746 as a purified solvent via lines 722, 744. The purified solvent in a source 746 may have a purity of greater than 99 wt % to 99.99 wt %. For example, the purified solvent in a source 746 may have a purity of greater than 99 wt %, about 99.1 wt %, about 99.2 wt %, about 99.3 wt %, about 99.4 wt %, about 99.5 wt %, about 99.6 wt %, about 99.7 wt %, about 99.8 wt %, about 99.9 wt %, about 99.95 wt %, or 99.99 wt %. In one or more examples, the purified solvent in a source 746 may have a purity of greater than 99 wt % to 99.99 wt %, about 99.2 wt % to 99.99 wt %, about 99.4 wt % to 99.99 wt %, about 99.5 wt % to 99.99 wt %, about 99.6 wt % to 99.99 wt %, about 99.8 wt % to 99.99 wt %, about 99.9 wt % to 99.99 wt %, or about 99.95 wt % to 99.99 wt %.

In one or more embodiments, the purified solvent stored in the source 746 has an intermediate purity within the system 700. The purified solvent stored in the source 746 has a purity greater than the water-solvent waste stream in source 706 and less than the purified solvent stored in the source 728. The source 746 may store and/or transport the purified solvent to further reuse in several portions of the hydrocarbon purification systems 200, 300 and/or the system 600, such as in the extraction columns and the reactors.

In one or more examples, the source 728 may be one or more of the primary solvent source 225a, 225b fluidly coupled to and upstream of the upper portion of the laminar flow reactor 230 in the hydrocarbon purification system 200. The primary solvent source 225a, 225b may supply and introduce the purified solvent into the laminar flow reactor 230. In some examples, the source 728 may introduce the purified solvent into the separation unit 245 in the hydrocarbon purification system 200.

In other examples, the source 728 may be the primary solvent source 356 via line 358 fluidly coupled to the laminar flow reactor 350 and configured to introduce one or more solvents in the hydrocarbon purification system 300. In some examples, the source 728 may be the recycled feedstock hydrocarbon in line 307 fluidly coupled to the laminar flow reactor 350 and configured to introduce one or more solvents in the hydrocarbon purification system 300. In other examples, the source 728 may introduce the purified solvent into the laminar flow reactor 350 in the hydrocarbon purification system 300.

In one or more examples, the source 728 may be the water-solvent purification system 650 and/or is configured to supply solvent to the hydrocarbon source 602 which is fluidly coupled to the laminar flow reactor 610 via line 604 and configured to introduce one or more solvents in the hydrocarbon purification system 600. In some examples, the source 728 may be the water-solvent purification system 650 and/or is configured to supply solvent to the primary solvent source 606 which is fluidly coupled to the laminar flow reactor 610 via line 608 and configured to introduce one or more solvents in the hydrocarbon purification system 600. In other examples, the source 728 may introduce the purified solvent into the separation unit 622 in the hydrocarbon purification system 600.

In one or more examples, the source 746 may introduce the purified solvent into the separation unit 245 in the hydrocarbon purification system 200.

In other examples, the source 746 may be the recycled feedstock hydrocarbon in line 307 fluidly coupled to the laminar flow reactor 350 and configured to introduce one or more solvents in the hydrocarbon purification system 300. In other examples, the source 746 may introduce the purified solvent into the laminar flow reactor 350 in the hydrocarbon purification system 300.

In one or more examples, the source 746 may be the water-solvent purification system 650 and/or is configured to supply solvent to the hydrocarbon source 602 which is fluidly coupled to the laminar flow reactor 610 via line 604 and configured to introduce one or more solvents in the hydrocarbon purification system 600. In some examples, the source 746 may introduce the purified solvent into the separation unit 622 in the hydrocarbon purification system 600.

The concentrate of the water-solvent waste stream via line 716 may be transferred to and introduced into a dryer unit 734. Also, the concentrate via line 732 may be transferred to and introduced into the dryer unit 734. The concentrates via line 716 and/or via line 732 may independently be dried or may be combined and then dried by the dryer unit 734 to produce a distilled solvent stream via line 736 and a byproducts stream via line 740. The distilled solvent stream via line 736 is transferred to and stored in the source 738, and then transferred to the source 746. The byproducts stream via line 740 is transferred to a byproducts source 742. The byproducts stream may be a solid and/or have a desired moisture concentration. In one or more examples, one or more byproducts from the byproducts stream via line 740 is combined and mixed with one or more products within a mixer or other device. The product may be or contain one or more of a processed grain, vegetable meal, fruit meal, protein meal, meat, stover, hay, forage, or any combination thereof. The mixer may be or contain one or more of a tumbler mixer, paddle mixer, cone mixer, screw mixer, or any combination thereof.

### Example

In one or more examples, the hydrocarbon purification systems described and discussed herein, including the hydrocarbon purification systems 200, 300) and the processes and methods described and discussed herein, including the method 100, have been used to achieved the fat and oil purification (pretreatment) results provided as in Table 1. Most notable is purifying fat and oil to the level of non-detectable (ND) concentrations and/or very low concentrations for phosphorus, total metals, and chloride.

TABLE 1
Purified Hydrocarbons

| | Hydrocarbon Source | | | | | | | |
|---|---|---|---|---|---|---|---|---|
| | P | | Total | | Cl | | N | |
| | (ppm) | | Metals | | (ppm) | | (ppm) | |
| | Start (S), Final (F) | | | | | | | |
| | S | F | S | F | S | F | S | F |
| 300 ppm P SBO | 357 | <1 | 315 | <1 | 1 | ND | 150 | 50 |
| 500 ppm P SBO | 589 | <1 | 542 | ND | 1 | 1 | 180 | 74 |
| 1000 ppm P SBO | 1100 | <2 | 1095 | <1 | <2 | <2 | 343 | 125 |
| DCO | 4 | <0.5 | 26 | ND | 3 | 1 | 27 | 27 |
| Low-Grade DCO | 397 | 2 | 687 | 4 | 12 | ND | 270 | 135 |
| SBO Blend w/Tallow & YG | 87 | <1 | NA | <1 | NA | <2 | NA | 43 |
| Beef Tallow | 104 | ND | 132 | <4 | 70 | <2 | 155 | 155 |
| Poultry Fat | 320 | <1.5 | 156 | <8 | 10 | <2 | 680 | 580 |
| Canola Oil | 58 | <1.5 | 28 | ND | <1 | <1 | 35 | 26 |
| Camelina Oil | 27 | ND | 45 | 4 | ND | ND | 12 | 9 |
| Used Cooking Oil | 7.5 | <1.5 | 11 | <2 | 33 | <15 | 121 | 100 |

NOTES:
SBO = soybean oil
DCO = ethanol distiller's corn oil
YG = yellow grease
NA = not available
ND = not detected
Total Metals include Na, K, Mg, Ca, Fe

### Exemplary Embodiments

The present disclosure provides, among others, the following embodiments, each of which may be considered as optionally including any alternate embodiments per one or more of the following Clauses 1-64:

Clause 1. A method of purifying a hydrocarbon, comprising: flowing a feedstock hydrocarbon stream through a heating unit to produce a heated hydrocarbon stream, wherein the feedstock hydrocarbon stream has an initial concentration of a contaminant and comprises one or more of an oil, a fat, a grease, or any combination thereof; combining the heated hydrocarbon stream and a primary solvent in a laminar flow reactor to produce a hydrocarbon-solvent stream; flowing the hydrocarbon-solvent stream through a cooling unit to produce a cooled hydrocarbon-solvent stream; and introducing the cooled hydrocarbon-solvent stream into a separation unit to produce a scrubbed hydrocarbon stream and a solvent stream, wherein the scrubbed hydrocarbon stream has a final concentration of the contaminant, and wherein the final concentration of the contaminant is less than the initial concentration of the contaminant.

Clause 2. A method of purifying a hydrocarbon, comprising: flowing a feedstock hydrocarbon stream through a deaerator to degas the feedstock hydrocarbon stream, wherein the feedstock hydrocarbon stream has an initial concentration of a contaminant and comprises soybean oil, corn oil, canola oil, camelina oil, yellow grease, choice white grease, beef tallow, poultry fat, used cooking oil, tall oil, pyrolysis oil, or any combination thereof; flowing the degassed feedstock hydrocarbon stream through a heating unit to produce a heated hydrocarbon stream; combining the heated hydrocarbon stream and steam in a laminar flow reactor to produce an aqueous hydrocarbon stream; flowing the aqueous hydrocarbon stream through a cooling unit to produce a cooled aqueous hydrocarbon stream; introducing the cooled aqueous hydrocarbon stream into a vertical extraction column to produce a scrubbed hydrocarbon stream and an aqueous stream by a countercurrent liquid-liquid extraction, wherein the aqueous stream comprises the contaminant; and flowing the scrubbed hydrocarbon stream through a first finishing unit to produce a purified hydrocarbon stream, wherein the purified hydrocarbon stream has a final concentration of the contaminant, and wherein the initial concentration of the contaminant is about 40 times or greater than the final concentration of the contaminant.

Clause 3. A method of purifying a hydrocarbon, comprising: flowing a feedstock hydrocarbon stream through a heating unit to produce a heated hydrocarbon stream, wherein the feedstock hydrocarbon stream has an initial concentration of a contaminant and comprises one or more of an oil, a fat, a grease, or any combination thereof; combining the heated hydrocarbon stream and a primary solvent in a laminar flow reactor to produce a hydrocarbon-solvent stream, wherein producing the hydrocarbon-solvent stream further comprises: introducing a flow of the heated hydrocarbon stream into a headspace in an upper portion of the laminar flow reactor, wherein the flow of the heated hydrocarbon stream is completely or substantially free of turbulence, and wherein the heated hydrocarbon stream is at a first temperature; introducing a flow of the primary solvent into the headspace in the upper portion of the laminar flow reactor, wherein the flow of the primary solvent is completely or substantially free of turbulence, and wherein the primary solvent is at a second temperature greater than the first temperature; and condensing the primary solvent into the heated hydrocarbon stream to produce an intermediate stream; and flowing the intermediate stream through a reaction zone disposed in a lower portion of the laminar flow reactor to produce the hydrocarbon-solvent stream; introducing the hydrocarbon-solvent stream into a separation unit to produce a scrubbed hydrocarbon stream and a solvent stream, wherein the solvent stream comprises the contaminant; and flowing the scrubbed hydrocarbon stream through a first finishing unit to produce a purified hydrocarbon stream, wherein the purified hydrocarbon stream has a final concentration of the contaminant, and wherein the final concentration of the contaminant is less than the initial concentration of the contaminant.

Clause 4. A system for purifying a hydrocarbon, comprising: a deaerator fluidly coupled to and downstream of a feedstock hydrocarbon source, wherein the feedstock hydrocarbon source is configured to contain a feedstock hydrocarbon having an initial concentration of a contaminant and comprising one or more of an oil, a fat, a grease, or any combination thereof; a heating portion of a recuperator fluidly coupled to and downstream of the deaerator; an additive source fluidly coupled to and downstream of the deaerator, wherein the additive source is configured to contain an additive comprising a hydrolyzing agent, an acid, a base, a salt, a chelating agent, a polar solvent, a non-polar solvent, or any combination thereof; a laminar flow reactor comprising an upper portion opposite a lower portion, and wherein the upper portion of the laminar flow reactor is fluidly coupled to and downstream of the heating portion of the recuperator; a primary solvent source fluidly coupled to and upstream of the upper portion of the laminar flow reactor; a cooling portion of the recuperator fluidly coupled to and downstream of the lower portion of the laminar flow reactor; a pressure reduction device fluidly coupled to and downstream of the cooling portion of the recuperator; a separation unit fluidly coupled to and downstream of the pressure reduction device, wherein the separation unit comprises a scrubbed hydrocarbon stream outlet and a solvent stream outlet; a first finishing unit fluidly coupled to and downstream of the scrubbed hydrocarbon stream outlet, wherein the first finishing unit comprises a centrifuge, a cross-flow filtration unit, a coalescer, a decanter, an electrostatic separator, a membrane purifier, or any combination thereof, and wherein the first finishing unit comprises a purified hydrocarbon stream outlet configured to provide a purified hydrocarbon having a final concentration of the contaminant of at least 10 times less than the initial concentration of the contaminant; and a second finishing unit fluidly coupled to and downstream of the solvent stream outlet, wherein the second finishing unit comprises a centrifuge, a cross-flow filtration unit, a coalescer, a decanter, an electrostatic separator, a membrane purifier, or any combination thereof.

Clause 5. The method or the system according to any one of Clauses 1-4, wherein the primary solvent comprises a polar protic solvent, a polar aprotic solvent, a nonpolar hydrocarbon solvent, a nonpolar ether solvent, a nonpolar chlorocarbon solvent, or any combination thereof.

Clause 6. The method or the system according to any one of Clauses 1-5, wherein the primary solvent comprises water, steam, or a combination thereof.

Clause 7. The method or the system according to any one of Clauses 1-6, wherein the feedstock hydrocarbon stream comprises soybean oil, corn oil, canola oil, camelina oil, yellow grease, choice white grease, beef tallow, poultry fat, used cooking oil, tall oil, pyrolysis oil, or any combination thereof.

Clause 8. The method or the system according to any one of Clauses 1-7, wherein the feedstock hydrocarbon stream further comprises a polymeric material, a plastic material, or any combination thereof.

Clause 9. The method or the system according to any one of Clauses 1-8, wherein the contaminant comprises one or more of a halide (e.g., Cl, F, Br, I), phosphorous, sulfur, nitrogen, a gum or lecithin, an alkali metal, a metalloid, a heavy metal, or any combination thereof.

Clause 10. The method or the system according to any one of Clauses 1-9, prior to flowing the feedstock hydrocarbon stream through the heating unit, further comprising flowing the feedstock hydrocarbon stream through a deaerator to degas the feedstock hydrocarbon stream. [00160]11. The method or the system according to any one of Clauses 1-10, further comprising combining an additive into the feedstock hydrocarbon stream, the heated hydrocarbon stream, or both the feedstock hydrocarbon stream and the heated hydrocarbon stream, wherein the additive comprises a hydrolyzing agent, an acid, a base, a salt, a chelating agent, a polar solvent, a non-polar solvent, or any combination thereof.

Clause 12. The method or the system according to any one of Clauses 1-11, wherein the additive comprises one or more of acetic acid, ascorbic acid, citric acid, hydrochloric acid, fumaric acid, glucaric acid, gluconic acid, glutamic acid, hydrochloric acid, lactic acid, malic acid, oxalic acid, phosphoric acid, propionic acid, sulfuric acid, tartaric acid, salts thereof, or any combination thereof.

Clause 13. The method or the system according to any one of Clauses 1-12, further comprising introducing and combining the heated hydrocarbon stream, an additive, and the primary solvent in the laminar flow reactor to produce the hydrocarbon-solvent stream.

Clause 14. The method or the system according to any one of Clauses 1-13, wherein the heating unit comprises a recuperator, a steam heater, an electric heater, a fuel combustion heater, or any combination thereof.

Clause 15. The method or the system according to any one of Clauses 1-14, wherein the heated hydrocarbon stream is produced by flowing the feedstock hydrocarbon stream through a heating portion of a recuperator, and then at least one of a steam heater, an electric heater, a fuel combustion heater, or any combination thereof.

Clause 16. The method or the system according to any one of Clauses 1-15, wherein the heated hydrocarbon stream is flowed into a primary solvent pocket within an upper portion of the laminar flow reactor, and wherein the primary solvent pocket comprises the primary solvent; and/or optionally, wherein the primary solvent is combined with the heated hydrocarbon stream prior to being introduced into the laminar flow reactor.

Clause 17. The method or the system according to any one of Clauses 1-16, wherein the primary solvent is introduced into the laminar flow reactor through an injection device, and wherein the primary solvent has a pressure drop across the injection device in a range from about 0.0001 psi to about 40 psi.

Clause 18. The method or the system according to any one of Clauses 1-17, wherein the primary solvent comprises steam, wherein a first source of the steam is combined with the heated hydrocarbon stream prior to being introduced into the laminar flow reactor, a combination of the first source of the steam and the heated hydrocarbon stream is flowed into a steam pocket within an upper portion of the laminar flow reactor, and wherein the steam pocket comprises a second source of the steam.

Clause 19. The method or the system according to any one of Clauses 1-18, wherein the laminar flow reactor is a liquid-filled laminar flow reactor comprising an inflow distributor assembly, an outflow header assembly, a packing assembly, or any combination thereof.

Clause 20. The method or the system according to any one of Clauses 1-19, wherein the laminar flow reactor is a vapor-infused laminar flow reactor comprising an inflow distributor assembly, a packing assembly, or any combination thereof, and optionally wherein the vapor-infused laminar flow contains steam and/or one or more organic solvents.

Clause 21. The method or the system according to any one of Clauses 1-20, wherein the cooled hydrocarbon-solvent stream is produced by flowing the hydrocarbon-solvent stream a recuperator, a coolant circulation system, a refrigeration system, or a combination thereof.

Clause 22. The method or the system according to any one of Clauses 1-21, wherein the cooled hydrocarbon-solvent stream is produced by flowing the hydrocarbon-solvent stream through a cooling portion of a recuperator, and wherein the heated hydrocarbon stream is produced by flowing the feedstock hydrocarbon stream through a heating portion of the recuperator.

Clause 23. The method or the system according to any one of Clauses 1-22, further comprising flowing the cooled hydrocarbon-solvent stream through a pressure reduction device, wherein the cooled hydrocarbon-solvent stream is at a first pressure entering the pressure reduction device and at a second pressure exiting the pressure reduction device, and wherein the first pressure is at least 10 times greater than the second pressure.

Clause 24. The method or the system according to any one of Clauses 1-23, wherein the first pressure is in a range from about 500 psi to about 1,500 psi, and the second pressure is in a range from about 1 psi to about 500 psi, and wherein the second pressure is at least one half of the value of the first pressure.

Clause 25. The method or the system according to any one of Clauses 1-24, wherein the pressure reduction device is a low-shear pressure reduction device, a cyclonic pressure reduction device, a multi-stage pressure reduction device, or any combination thereof.

Clause 26. The method or the system according to any one of Clauses 1-25, wherein the separation unit comprises an extraction column, a vertical extraction column, a horizontal extraction column, a centrifuge, a cross-flow filtration unit, a coalescer, a decanter, an electrostatic separator, a membrane purifier, or any combination thereof.

Clause 27. The method or the system according to any one of Clauses 1-26, wherein the separation unit comprises a vertical extraction column.

Clause 28. The method or the system according to any one of Clauses 1-27, further comprising: introducing the cooled hydrocarbon-solvent stream into a lower portion of the vertical extraction column; introducing a solvent or water stream into an upper portion of the vertical extraction column; performing a countercurrent liquid-liquid extraction by flowing the cooled hydrocarbon-solvent stream toward the upper portion of the vertical extraction column and flowing the solvent or water stream toward the lower portion of the vertical extraction column; and flowing the scrubbed hydrocarbon stream from the upper portion of the vertical extraction column, and flowing the solvent stream from the lower portion of the vertical extraction column.

Clause 29. The method or the system according to any one of Clauses 1-28, wherein the vertical extraction column comprises a packing assembly.

Clause 30. The method or the system according to any one of Clauses 1-29, wherein producing the hydrocarbon-solvent stream further comprises: introducing a flow of the heated hydrocarbon stream into a headspace in an upper portion of the laminar flow reactor, wherein the flow of the heated hydrocarbon stream is completely or substantially free of turbulence, and wherein the heated hydrocarbon stream is at a first temperature; introducing a flow of the primary solvent into the headspace in the upper portion of the laminar flow reactor, wherein the flow of the primary solvent is completely or substantially free of turbulence, and wherein the primary solvent is at a second temperature greater than the first temperature; and condensing the primary solvent into the heated hydrocarbon stream to produce an intermediate stream; and flowing the intermediate stream through a reaction zone disposed in a lower portion of the laminar flow reactor to produce the hydrocarbon-solvent stream.

Clause 31. The method or the system according to any one of Clauses 1-30, wherein the primary solvent comprises a polar protic solvent, a polar aprotic solvent, a nonpolar hydrocarbon solvent, a nonpolar ether solvent, a nonpolar chlorocarbon solvent, or any combination thereof; and/or wherein the primary solvent comprises water.

Clause 32. The method or the system according to any one of Clauses 1-31, wherein a liquid phase within the headspace of the laminar flow reactor has a Reynolds number in a range from about 0 to 2,300, or wherein each of the intermediate stream and/or the hydrocarbon-solvent stream independently has a Reynolds number in a range from about 0 to 2,300.

Clause 33. The method or the system according to any one of Clauses 1-32, further comprising flowing the scrubbed hydrocarbon stream through a first finishing unit to produce a purified hydrocarbon stream, wherein the purified hydrocarbon stream has the final concentration of the contaminant or a further reduced concentration of the contaminant.

Clause 34. The method or the system according to any one of Clauses 1-33, wherein the first finishing unit comprises a centrifuge, a cross-flow filtration unit, a coalescer, a decanter, an electrostatic separator, a membrane purifier, or any combination thereof.

Clause 35. The method or the system according to any one of Clauses 1-34, further comprising flowing an aqueous waste stream from the first finishing unit to a water purification system, wherein the aqueous waste stream comprises at least a portion of the contaminant.

Clause 36. The method or the system according to any one of Clauses 1-35, wherein the initial concentration of the contaminant is about 40 times, about 100 times, or greater than the final concentration of the contaminant.

Clause 37. The method or the system according to any one of Clauses 1-36, wherein the contaminant comprises phosphorus, the initial concentration of the phosphorous is 100 ppm or greater, and the final concentration of the phosphorus is less than 5 ppm, such as less than 2 ppm, or less than 1 ppm.

Clause 38. The method or the system according to any one of Clauses 1-37, wherein the contaminant comprises total metals, the initial concentration of the total metals is 40 ppm or greater, and the final concentration of the total metals is less than 5 ppm, less than 2 ppm, or less than 1 ppm, and optionally wherein the total metals contains sodium, potassium, magnesium, calcium, iron, or any combination thereof.

Clause 39. The method or the system according to any one of Clauses 1-38, further comprising flowing the solvent stream from the separation unit through a second finishing unit to produce a secondary hydrocarbon stream and a secondary solvent stream, wherein each of the solvent stream and the secondary solvent stream independently comprises water.

Clause 40. The method or the system according to any one of Clauses 1-39, wherein the second finishing unit comprises a centrifuge, a cross-flow filtration unit, a coalescer, a decanter, an electrostatic separator, a membrane purifier, or any combination thereof.

Clause 41. The method or the system according to any one of Clauses 1-40, wherein the secondary hydrocarbon stream is combined into the feedstock hydrocarbon stream, the feedstock hydrocarbon stream, or a combination thereof.

Clause 42. The method or the system according to any one of Clauses 1-41, wherein the secondary solvent stream is flowed to a water purification system, the laminar flow reactor, the separation unit, or a combination thereof.

Clause 43. The method or the system according to any one of Clauses 1-42, wherein each of the secondary solvent stream and/or the solvent stream is an aqueous stream, and wherein the aqueous stream is concentrated and/or dried and then blended with a product in a mixer, and wherein the product comprises a processed grain, vegetable meal, fruit meal, protein meal, meat, stover, hay, forage, or any combination thereof, and optionally wherein the mixer is or contains a tumbler mixer, paddle mixer, cone mixer, screw mixer, or any combination thereof.

Clause 44. The method or the system according to any one of Clauses 1-43, wherein the feedstock hydrocarbon stream contains a plastic or polymeric material and pyrolysis oils.

Clause 45. The method or the system according to any one of Clauses 1-44, wherein the primary solvent comprises a polar protic solvent, a polar aprotic solvent, a nonpolar hydrocarbon solvent, a nonpolar ether solvent, a nonpolar chlorocarbon solvent, or any combination thereof.

Clause 46. The method or the system according to any one of Clauses 1-45, wherein the primary solvent comprises water.

Clause 47. The method or the system according to any one of Clauses 1-46, wherein the primary solvent is introduced into the headspace through an injection device, and wherein the primary solvent has a pressure drop across the injection device in a range from about 0.0001 psi to about 80 psi, or about 0.0001 psi to about 60 psi, or about 0.0001 psi to about 40 psi, or about 0.0001 psi to about 20 psi, or about 0.0001 psi to about 10 psi, or about 0.0001 psi to about 5 psi, or about 0.0001 psi to about 1 psi, or about 0.0001 psi to about 0.1 psi.

Clause 48. The method or the system according to any one of Clauses 1-47, wherein the laminar flow reactor is maintained at a pressure in a range from about 1 psi to about 50 psi of a saturation pressure of the primary solvent at a target reaction temperature.

Clause 49. The method or the system according to any one of Clauses 1-48, wherein a reaction temperature in the laminar flow reactor is in a range from about 50° C. to about 400° C.

Clause 50. The method or the system according to any one of Clauses 1-49, wherein a second temperature in the laminar flow reactor is in a range from about 150° C. to about 300° C., or about 200° C. to about 275° C.

Clause 51. The method or the system according to any one of Clauses 1-50, wherein the primary solvent is introduced as a superheated vapor, a saturated vapor, or a subcooled vapor.

Clause 52. The method or the system according to any one of Clauses 1-51, wherein each of a liquid phase within the headspace of the laminar flow reactor and/or the intermediate stream and/or the hydrocarbon-solvent stream independently has a Reynolds number in a range from about 0 to 2,300.

Clause 53. The method or the system according to any one of Clauses 1-52, wherein each of a liquid phase within the headspace of the laminar flow reactor and/or the intermediate stream and/or the hydrocarbon-solvent stream independently has a Reynolds number in a range from about 0 to less than 2,000.

Clause 54. The method or the system according to any one of Clauses 1-53, wherein the primary solvent source is a steam source configured to store and disperse steam.

Clause 55. The method or the system according to any one of Clauses 1-54, wherein the laminar flow reactor is a liquid-filled laminar flow reactor comprising an inflow distributor assembly, an outflow header assembly, a packing assembly, or any combination thereof.

Clause 56. The method or the system according to any one of Clauses 1-55, wherein the laminar flow reactor comprises an inflow distributor assembly in the upper portion and an outflow header assembly in the lower portion.

Clause 57. The method or the system according to any one of Clauses 1-56, wherein the laminar flow reactor is a vapor-infused laminar flow reactor comprising an inflow distributor assembly, a packing assembly, or any combination thereof.

Clause 58. The method or the system according to any one of Clauses 1-57, wherein the pressure reduction device is a low-shear pressure reduction device, a cyclonic pressure reduction device, a multi-stage pressure reduction device, or any combination thereof.

Clause 59. The method or the system according to any one of Clauses 1-58, wherein the separation unit comprises an extraction column, a vertical extraction column, a horizontal extraction column, a centrifuge, a cross-flow filtration unit, a coalescer, a decanter, an electrostatic separator, a membrane purifier, or any combination thereof.

Clause 60. The method or the system according to any one of Clauses 1-59, wherein the separation unit comprises a vertical extraction column.

Clause 61. The method or the system according to any one of Clauses 1-60, wherein the vertical extraction column comprises: an upper portion opposite a lower portion; an upper inlet in the upper portion configured to receive a solvent or water stream; a lower inlet in the lower portion coupled to and downstream of the pressure reduction device, and wherein the lower inlet configured to receive a cooled hydrocarbon-solvent stream; a central region disposed between the upper and lower portions and configured to perform a countercurrent liquid-liquid extraction by flowing the cooled hydrocarbon-solvent stream toward the upper portion of the vertical extraction column and flowing the solvent or water stream toward the lower portion of the vertical extraction column; a scrubbed hydrocarbon stream outlet disposed in the upper portion of the vertical extraction column; and a solvent stream outlet disposed in the lower portion of the vertical extraction column.

Clause 62. The method or the system according to any one of Clauses 1-61, wherein the central region comprises a packing assembly.

Clause 63. The method or the system according to any one of Clauses 1-62, further comprising a supplemental heating unit fluidly coupled to and downstream of the deaerator and fluidly coupled to and upstream of the laminar flow reactor.

Clause 64. The method or the system according to any one of Clauses 1-63, wherein the supplemental heating unit comprises a second recuperator, a steam heater, an electric heater, a fuel combustion heater, or any combination thereof.

While the foregoing is directed to embodiments of the disclosure, other and further embodiments may be devised without departing from the basic scope thereof, and the scope thereof is determined by the claims that follow. All documents described herein are incorporated by reference herein, including any priority documents and/or testing procedures to the extent they are not inconsistent with this text. As is apparent from the foregoing general description and the specific embodiments, while forms of the present disclosure have been illustrated and described, various modifications may be made without departing from the spirit and scope of the present disclosure. Accordingly, it is not intended that the present disclosure be limited thereby. Likewise, the term “comprising” is considered synonymous with the term “including” for purposes of United States law. Likewise, whenever a composition, an element, or a group of elements is preceded with the transitional phrase “comprising”, it is understood that the same composition or group of elements with transitional phrases “consisting essentially of”, “consisting of”, “selected from the group of consisting of”, or “is” preceding the recitation of the composition, element, or elements and vice versa, are contemplated. As used herein, the term “about” refers to a +/−10% variation from the nominal value. It is to be understood that such a variation may be included in any value provided herein.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below.

What is claimed is:

1. A method of purifying a hydrocarbon, comprising:
flowing a feedstock hydrocarbon stream through a heating unit to produce a heated hydrocarbon stream, wherein the feedstock hydrocarbon stream has an initial concentration of a contaminant and comprises one or more of an oil, a fat, a grease, or any combination thereof;
combining the heated hydrocarbon stream and a primary solvent in a laminar flow reactor to produce a hydrocarbon-solvent stream;
flowing the hydrocarbon-solvent stream through a cooling unit to produce a cooled hydrocarbon-solvent stream; and
introducing the cooled hydrocarbon-solvent stream into a separation unit to produce a scrubbed hydrocarbon stream and a solvent stream, wherein the scrubbed hydrocarbon stream has a final concentration of the contaminant, and wherein the final concentration of the contaminant is less than the initial concentration of the contaminant.

2. The method of claim 1, wherein the primary solvent comprises water, steam, or a combination thereof.

3. The method of claim 1, wherein the feedstock hydrocarbon stream comprises soybean oil, corn oil, canola oil, camelina oil, yellow grease, choice white grease, beef tallow, poultry fat, used cooking oil, tall oil, pyrolysis oil, or any combination thereof.

4. The method of claim 1, wherein the feedstock hydrocarbon stream further comprises a polymeric material, a plastic material, or any combination thereof.

5. The method of claim 1, wherein the contaminant comprises one or more of a halide, phosphorous, sulfur, nitrogen, a gum or lecithin, an alkali metal, a metalloid, a heavy metal, or any combination thereof.

6. The method of claim 1, prior to flowing the feedstock hydrocarbon stream through the heating unit, further comprising flowing the feedstock hydrocarbon stream through a deaerator to degas the feedstock hydrocarbon stream.

7. The method of claim 1, further comprising combining an additive into the feedstock hydrocarbon stream, the heated hydrocarbon stream, or both the feedstock hydrocarbon stream and the heated hydrocarbon stream, wherein the additive comprises a hydrolyzing agent, an acid, a base, a salt, a chelating agent, a polar solvent, a non-polar solvent, or any combination thereof.

8. The method of claim 7, wherein the additive comprises one or more of acetic acid, ascorbic acid, citric acid, hydrochloric acid, fumaric acid, glucaric acid, gluconic acid, glutamic acid, hydrochloric acid, lactic acid, malic acid, oxalic acid, phosphoric acid, propionic acid, sulfuric acid, tartaric acid, salts thereof, or any combination thereof.

9. The method of claim 1, further comprising introducing and combining the heated hydrocarbon stream, an additive, and the primary solvent in the laminar flow reactor to produce the hydrocarbon-solvent stream.

10. The method of claim 1, wherein the heated hydrocarbon stream is flowed into a primary solvent pocket within an upper portion of the laminar flow reactor, and wherein the primary solvent pocket comprises the primary solvent.

11. The method of claim 1, wherein the primary solvent is combined with the heated hydrocarbon stream prior to being introduced into the laminar flow reactor.

12. The method of claim 1, wherein the primary solvent comprises steam, wherein a first source of the steam is combined with the heated hydrocarbon stream prior to being introduced into the laminar flow reactor, a combination of the first source of the steam and the heated hydrocarbon stream is flowed into a steam pocket within an upper portion of the laminar flow reactor, and wherein the steam pocket comprises a second source of the steam.

13. The method of claim 1, wherein the laminar flow reactor is a liquid-filled laminar flow reactor comprising an inflow distributor assembly, an outflow header assembly, a packing assembly, or any combination thereof.

14. The method of claim 1, wherein the laminar flow reactor is a vapor-infused laminar flow reactor comprising an inflow distributor assembly, a packing assembly, or any combination thereof.

15. The method of claim 1, further comprising flowing the cooled hydrocarbon-solvent stream through a pressure reduction device, wherein the cooled hydrocarbon-solvent stream is at a first pressure entering the pressure reduction device and at a second pressure exiting the pressure reduction device, and wherein the first pressure is in a range from about 500 psi to about 1,500 psi, and the second pressure is in a range from about 1 psi to about 500 psi, and wherein the second pressure is at least one half of the value of the first pressure.

16. The method of claim 1, wherein the separation unit comprises an extraction column, a vertical extraction column, a horizontal extraction column, a centrifuge, a cross-flow filtration unit, a coalescer, a decanter, an electrostatic separator, a membrane purifier, or any combination thereof.

17. The method of claim 1, wherein the separation unit comprises a vertical extraction column.

18. The method of claim 17, further comprising:
introducing the cooled hydrocarbon-solvent stream into a lower portion of the vertical extraction column;
introducing a solvent or water stream into an upper portion of the vertical extraction column;
performing a countercurrent liquid-liquid extraction by flowing the cooled hydrocarbon-solvent stream toward the upper portion of the vertical extraction column and flowing the solvent or water stream toward the lower portion of the vertical extraction column; and
flowing the scrubbed hydrocarbon stream from the upper portion of the vertical extraction column, and flowing the solvent stream from the lower portion of the vertical extraction column.

19. The method of claim 17, wherein the vertical extraction column comprises a packing assembly.

20. The method of claim 1, wherein producing the hydrocarbon-solvent stream further comprises:
introducing a flow of the heated hydrocarbon stream into a headspace in an upper portion of the laminar flow reactor, wherein the flow of the heated hydrocarbon stream is completely or substantially free of turbulence, and wherein the heated hydrocarbon stream is at a first temperature;
introducing a flow of the primary solvent into the headspace in the upper portion of the laminar flow reactor, wherein the flow of the primary solvent is completely or substantially free of turbulence, and wherein the primary solvent is at a second temperature greater than the first temperature; and
condensing the primary solvent into the heated hydrocarbon stream to produce an intermediate stream; and
flowing the intermediate stream through a reaction zone disposed in a lower portion of the laminar flow reactor to produce the hydrocarbon-solvent stream.

21. The method of claim 20, wherein each of a liquid phase within the headspace of the laminar flow reactor and/or the intermediate stream and/or the hydrocarbon-solvent stream independently has a Reynolds number in a range from about 0 to 2,300.

22. The method of claim 1, further comprising flowing the scrubbed hydrocarbon stream through a first finishing unit to produce a purified hydrocarbon stream, wherein the purified hydrocarbon stream has the final concentration of the contaminant or a further reduced concentration of the contaminant.

23. The method of claim 1, wherein the initial concentration of the contaminant is about 40 times or greater than the final concentration of the contaminant.

24. The method of claim 1, wherein the contaminant comprises phosphorus, the initial concentration of the phosphorous is 100 ppm or greater, and the final concentration of the phosphorus is less than 5 ppm, and/or wherein the contaminant comprises total metals, the initial concentration of the total metals is 40 ppm or greater, and the final concentration of the total metals is less than 5 ppm.

25. The method of claim 1, wherein the solvent stream is an aqueous stream, and wherein the aqueous stream is concentrated and/or dried and then blended with a product in a mixer, and wherein the product comprises a processed grain, vegetable meal, fruit meal, protein meal, meat, stover, hay, forage, or any combination thereof.

26. The method of claim 1, further comprising flowing the solvent stream from the separation unit through a second finishing unit to produce a secondary hydrocarbon stream and a secondary solvent stream, wherein each of the solvent stream and the secondary solvent stream independently comprises water.

27. The method of claim 26, wherein the secondary hydrocarbon stream is combined into the feedstock hydrocarbon stream, the feedstock hydrocarbon stream, or a combination thereof.

28. The method of claim 26, wherein the secondary solvent stream is flowed to a water purification system, the laminar flow reactor, the separation unit, or a combination thereof.

29. The method of claim 26, wherein the secondary solvent stream is an aqueous stream, and wherein the aqueous stream is concentrated and/or dried and then blended with a product in a mixer, and wherein the product comprises a processed grain, vegetable meal, fruit meal, protein meal, meat, stover, hay, forage, or any combination thereof.

30. A method of purifying a hydrocarbon, comprising:
flowing a feedstock hydrocarbon stream through a deaerator to degas the feedstock hydrocarbon stream, wherein the feedstock hydrocarbon stream has an initial concentration of a contaminant and comprises soybean oil, corn oil, canola oil, camelina oil, yellow grease, choice white grease, beef tallow, poultry fat, used cooking oil, tall oil, pyrolysis oil, or any combination thereof;
flowing the degassed feedstock hydrocarbon stream through a heating unit to produce a heated hydrocarbon stream;
combining the heated hydrocarbon stream and steam in a laminar flow reactor to produce an aqueous hydrocarbon stream;
flowing the aqueous hydrocarbon stream through a cooling unit to produce a cooled aqueous hydrocarbon stream;
introducing the cooled aqueous hydrocarbon stream into a vertical extraction column to produce a scrubbed hydrocarbon stream and an aqueous stream by a countercurrent liquid-liquid extraction, wherein the aqueous stream comprises the contaminant; and
flowing the scrubbed hydrocarbon stream through a first finishing unit to produce a purified hydrocarbon stream, wherein the purified hydrocarbon stream has a final concentration of the contaminant, and wherein the initial concentration of the contaminant is about 40 times or greater than the final concentration of the contaminant.

31. A method of purifying a hydrocarbon, comprising:
flowing a feedstock hydrocarbon stream through a heating unit to produce a heated hydrocarbon stream, wherein the feedstock hydrocarbon stream has an initial concentration of a contaminant and comprises one or more of an oil, a fat, a grease, or any combination thereof;
combining the heated hydrocarbon stream and a primary solvent in a laminar flow reactor to produce a hydrocarbon-solvent stream, wherein producing the hydrocarbon-solvent stream further comprises:
introducing a flow of the heated hydrocarbon stream into a headspace in an upper portion of the laminar flow reactor, wherein the flow of the heated hydrocarbon stream is completely or substantially free of turbulence, and wherein the heated hydrocarbon stream is at a first temperature;
introducing a flow of the primary solvent into the headspace in the upper portion of the laminar flow reactor, wherein the flow of the primary solvent is completely or substantially free of turbulence, and wherein the primary solvent is at a second temperature greater than the first temperature; and
condensing the primary solvent into the heated hydrocarbon stream to produce an intermediate stream; and
flowing the intermediate stream through a reaction zone disposed in a lower portion of the laminar flow reactor to produce the hydrocarbon-solvent stream;
introducing the hydrocarbon-solvent stream into a separation unit to produce a scrubbed hydrocarbon stream and a solvent stream, wherein the solvent stream comprises the contaminant; and
flowing the scrubbed hydrocarbon stream through a first finishing unit to produce a purified hydrocarbon stream, wherein the purified hydrocarbon stream has a final concentration of the contaminant, and wherein the final concentration of the contaminant is less than the initial concentration of the contaminant.

32. The method of claim 31, wherein the primary solvent comprises water or steam.

33. The method of claim 31, wherein the solvent stream is an aqueous stream, and wherein the aqueous stream is concentrated and/or dried and then blended with a product in a mixer, and wherein the product comprises a processed grain, vegetable meal, fruit meal, protein meal, meat, stover, hay, forage, or any combination thereof.

34. The method of claim 31, wherein the primary solvent is introduced into the headspace through an injection device, and wherein the primary solvent has a pressure drop across the injection device in a range from about 0.0001 psi to about 40 psi.

35. The method of claim 31, wherein the laminar flow reactor is maintained at a pressure in a range from about 1 psi to about 50 psi of a saturation pressure of the primary solvent at a target reaction temperature.

36. The method of claim 31, wherein each of a liquid phase within the headspace of the laminar flow reactor and/or the intermediate stream and/or the hydrocarbon-solvent stream independently has a Reynolds number in a range from about 0 to 2,300.

37. A system for purifying a hydrocarbon, comprising:
a deaerator fluidly coupled to and downstream of a feedstock hydrocarbon source, wherein the feedstock hydrocarbon source is configured to contain a feedstock hydrocarbon having an initial concentration of a contaminant and comprising one or more of an oil, a fat, a grease, or any combination thereof;
a heating portion of a recuperator fluidly coupled to and downstream of the deaerator;
an additive source fluidly coupled to and downstream of the deaerator, wherein the additive source is configured to contain an additive comprising a hydrolyzing agent, an acid, a base, a salt, a chelating agent, a polar solvent, a non-polar solvent, or any combination thereof;
a laminar flow reactor comprising an upper portion opposite a lower portion, and wherein the upper portion of the laminar flow reactor is fluidly coupled to and downstream of the heating portion of the recuperator;
a primary solvent source fluidly coupled to and upstream of the upper portion of the laminar flow reactor;
a cooling portion of the recuperator fluidly coupled to and downstream of the lower portion of the laminar flow reactor;
a pressure reduction device fluidly coupled to and downstream of the cooling portion of the recuperator;
a separation unit fluidly coupled to and downstream of the pressure reduction device, wherein the separation unit comprises a scrubbed hydrocarbon stream outlet and a solvent stream outlet;
a first finishing unit fluidly coupled to and downstream of the scrubbed hydrocarbon stream outlet, wherein the first finishing unit comprises a centrifuge, a cross-flow filtration unit, a coalescer, a decanter, an electrostatic separator, a membrane purifier, or any combination thereof, and wherein the first finishing unit comprises a purified hydrocarbon stream outlet configured to provide a purified hydrocarbon having a final concentration of the contaminant of at least 10 times less than the initial concentration of the contaminant; and
a second finishing unit fluidly coupled to and downstream of the solvent stream outlet, wherein the second finishing unit comprises a centrifuge, a cross-flow filtration unit, a coalescer, a decanter, an electrostatic separator, a membrane purifier, or any combination thereof.
